(19) United States
(12) Patent Application Publication
(10) Pub. No.: US 2019/0323384 A1
(43) Pub. Date: Oct. 24, 2019

(54) BOILOR PLANT AND METHOD FOR OPERATING THE SAME

(71) Applicant: MITSUBISHI HEAVY INDUSTRIES, LTD., Tokyo (JP)

(72) Inventors: Hideyuki UECHI, Tokyo (JP); Kuniaki AOYAMA, Tokyo (JP)

(21) Appl. No.: 16/366,166

(22) Filed: Mar. 27, 2019

(30) Foreign Application Priority Data
Mar. 29, 2018 (JP) 2018-065213

(51) Int. Cl. F01K 23/10; F01K 7/22; F02C 7/141

(52) U.S. Cl. CPC F01K 23/106; F02C 7/141; F01K 7/22

(57) ABSTRACT

A boiler plant includes a boiler which is configured to heat water by a heating fluid to generate steam, a steam utilization device which is configured to use the steam from the boiler, and a heating device which is configured to heat steam using at least energy excluding thermal energy of the heating fluid. The boiler has one or more evaporators which heat water or steam. A first evaporator having a highest internal pressure from among one or more evaporators is configured to heat water or steam having a temperature lower than a constant pressure specific heat maximum temperature, at which constant pressure specific heat in a pressure in the first evaporator is maximum, to be equal to or higher than the constant pressure specific heat maximum temperature. The heating device is configured to heat the steam having a temperature lower than the constant pressure specific heat maximum temperature to be equal to or higher than the constant pressure specific heat maximum temperature.

### TECHNICAL FIELD OF THE INVENTION

The present invention relates to a boiler plant including a boiler which generates steam and a steam utilization device which uses the steam from the boiler, and a method for operating the same.

Priority is claimed on Japanese Patent Application No. 2018-065213, filed on Mar. 29, 2018, the content of which is incorporated herein by reference.

### RELATED ART

A boiler plant described in the following Patent Document 1 includes a gas turbine, an exhaust heat recovery boiler which generates steam using heat of a heating fluid which is an exhaust gas from the gas turbine, and a plurality of steam turbines.

In this boiler plant, the plurality of steam turbines include a high pressure steam turbine, an intermediate pressure steam turbine which is driven by the steam exhausted from the high pressure steam turbine, and a low pressure steam turbine which is driven by steam which is exhausted from the intermediate pressure steam turbine and is reheated. The exhaust heat recovery boiler has a high pressure economizer (HPECO1) which heats water supplied to the high pressure steam turbine, a high pressure evaporator (HPEVA) which heats the water heated by the high pressure economizer (HPECO1) to generate steam, a downstream high pressure superheater (HPSH2) which superheats the steam generated by the high pressure evaporator (HPEVA), a upstream high pressure superheater (HPSH1) which further superheats the steam superheated by the downstream high pressure superheater (HPSH2), a downstream reheater (RH2) which heats the steam exhausted from the intermediate pressure steam turbine, and an upstream reheater (RH1) which further heats the steam heated by the downstream reheater (RH2). The steam superheated by the upstream high pressure superheater (HPSH1) is supplied to the high pressure steam turbine as a high pressure steam. In addition, the steam heated by the upstream reheater (RH1) is supplied to the low pressure steam turbine as a reheated steam.

The downstream reheater (RH2) is disposed on a downstream side of the high pressure evaporator (HPEVA) in a flow direction of the exhaust gas flowing into the exhaust heat recovery boiler. In addition, the upstream reheater (RH1) is disposed on an upstream side of the high pressure evaporator (HPEVA) in the flow direction of the exhaust gas. Accordingly, the steam, which is heated by the downstream reheater (RH2) disposed on the downstream side of the high pressure evaporator (HPEVA) and the upstream reheater (RH1) disposed on the upstream side of the high pressure evaporator (HPEVA), is supplied to the low pressure steam turbine.

### PRIOR ART DOCUMENT

### [Patent Document]

[Patent Document 1] Japanese Unexamined Patent Application, First Publication No. 2009-092372

### DISCLOSURE OF THE INVENTION

### Problems to be Solved by the Invention

In a boiler plant, it is desirable to effectively use heat of a heating fluid flowing through a boiler.

Accordingly, an object of the present invention is to provide a boiler plant capable of effectively using heated of a heating fluid flowing through a boiler, and a method for operating the same.

### Means for Solving the Problem

In order to achieve the object, according to an aspect of the present invention, there is provided a boiler plant including: a boiler which is configured to heat water by a heating fluid to generate steam; a steam utilization device which is configured to use the steam from the boiler; a connection line which connects the boiler and the steam utilization device to each other; a heating device which is configured to heat steam using at least energy excluding thermal energy of the heating fluid; a before-heating line through which steam is fed to the heating device; and an after-heating line through which the steam heated by the heating device is fed to a steam acceptance destination. The boiler has an intra-boiler line through which water or steam flows and one or more evaporators which heat water to generate steam. A first evaporator having a highest internal pressure, from among the one or more evaporators, is configured to heat water having a temperature lower than a constant pressure specific heat maximum temperature, at which constant pressure specific heat in a pressure in the first evaporator is maximum, to be equal to or higher than the constant pressure specific heat maximum temperature. The before-heating line is connected to a low temperature portion, from among the steam utilization device, the connection line, and the intra-boiler line, through which steam having a temperature lower than the constant pressure specific heat maximum temperature flows such that the steam in the low temperature portion is fed to the heating device. The heating device has ability to heat the steam in the low temperature portion to be equal to or higher than the constant pressure specific heat maximum temperature.

For example, the steam utilization device is set to a steam turbine group which is a collection of a plurality of steam turbines. When steam passes through the steam turbine group, as the energy drop of the steam increases, the output obtained from the entire steam turbine group increases. The steam exhausted from the steam turbine group is finally returned to water by a condenser, and thereafter, is returned to the boiler. The temperature and the pressure of the steam flowing into the condenser is necessarily determined by a temperature of water or the like which cools the steam in the condenser. In the one or more evaporators, the steam generated by the first evaporator having the highest internal pressure has the highest pressure and is expanded at a large pressure ratio up to the condenser, and an output can be extracted with a largest energy drop. That is, the value of the steam generated in the first evaporator is higher than a value of the steam generated in other evaporators. Accordingly, increasing a flow rate of the steam generated in the first evaporator is extremely important to increase an output and efficiency of the steam turbine group.

The first evaporator heats the water or steam having the temperature lower than the constant pressure specific heat maximum temperature, at which the constant pressure specific heat at the pressure in the first evaporator is maximum, to be equal to or higher than the constant pressure specific heat maximum temperature. A specific heat of the fluid at a temperature near this maximum temperature Tmax is large. Accordingly, in the first evaporator, lots of heat is required to increase the temperature. The flow rate of the steam which can be generated by the first evaporator is determined by a heat quantity at a temperature level near the constant pressure specific heat maximum temperature which is available in the first evaporator. Therefore, in order to increase the output and efficiency of the steam turbine group, it is extremely important to input lots of heat having a temperature level near the constant pressure specific heat maximum temperature to the first evaporator so as to increase the flow rate of the steam generated by the first evaporator.

In the present aspect, the steam or water which flows through the low temperature portion in the connection line and the intra-boiler line and has the temperature lower than the constant pressure specific heat maximum temperature is heated to be equal to or higher than the constant pressure specific heat maximum temperature by the heating device. The heating device has a heater which is configured to heat steam using only the energy excluding the thermal energy of the heating fluid flowing through the boiler. For this reason, the heat quantity of the temperature level near the constant pressure specific heat maximum temperature which can be consumed by the first evaporator out of a heat quantity of the heating fluid increases. Accordingly, the flow rate of the steam generated by the first evaporator increases, and thus, it is possible to increase the output and efficiency of the steam turbine group. That is, in the present aspect, the heat of the temperature level near the constant pressure specific heat maximum temperature out of the heat of the heating fluid can be effectively used by the first evaporator.

Here, in the boiler plant of the aspect, the heating device may have a heater which heats steam using only the energy excluding the thermal energy of the heating fluid.

In addition, in the boiler plant of the aspect, the steam utilization device may have a steam turbine.

In the boiler plant having the steam turbine, exhaust steam exhausted from the steam turbine via the before-heating line may flow into the heating device and the heating device may heat the exhaust steam exhausted from the steam turbine.

Moreover, in the boiler plant having the steam turbine, the steam utilization device may have a first steam turbine and a second steam turbine which is driven by steam having a pressure lower than that of the first steam turbine, as the steam turbine. In the case, the exhaust steam exhausted from the first steam turbine via the before-heating line may flow into the heating device, and the heating device may heat the exhaust steam and feed the heated exhaust steam to the second steam turbine via the after-heating line.

In the boiler plant having the steam turbine, the boiler may have a reheater which is configured to perform heat exchange between the exhaust steam exhausted from the steam turbine and the heating fluid to heat the exhaust steam. In this case, the heating device may have a heater which is configured to heat steam using only energy excluding the thermal energy of the heating fluid. The heater is configured to heat the exhaust steam which flows out from the reheater or the exhaust steam which flows into the reheater.

In the boiler plant having the reheater, the reheater may have a downstream reheater which is disposed on a downstream side in a flow direction of the heating fluid, with respect to the first evaporator. In this case, the heater is configured to heat the exhaust steam which is heated by the downstream reheater.

In the boiler plant having the reheater, the reheater may have an upstream reheater which is disposed at the same position as that of the first evaporator in a flow direction of the heating fluid or is disposed on an upstream side in the flow direction of the heating fluid with respect to the first evaporator. In this case, the upstream reheater is configured to heat the exhaust steam heated by the heater.

In the boiler plant having the upstream reheater, the heating device may have the heater and the upstream reheater.

In the boiler plant having the heater, the heater may have a plant outside heat exchanger which is configured to heat steam using heat in other plants.

In the boiler plant having the boiler, the boiler plant may further include a gas turbine which has a compressor which is configured to compress air, a combustor which is configured to combust a fuel in the air compressed by the compressor to generate a combustion gas, and a turbine which is driven by the combustion gas. In this case, the boiler is an exhaust heat recovery boiler which has an exhaust gas which is a combustion gas exhausted from the turbine, as the heating fluid.

In the boiler plant having the gas turbine, the boiler plant may further include an air cooler which is configured to perform heat exchange between a portion of high-temperature and high-pressure air compressed by the compressor and a first cooling medium, heat the first cooling medium while cooling the air from the compressor, and feed the cooled air to a high temperature component of the gas turbine being in contact with the combustion gas. In this case, the heater has the air cooler which has steam, which is a heating target of the heater, as the first cooling medium.

In the boiler plant having the gas turbine, a medium passage through which a second cooling medium passes may be formed in a high temperature component of the gas turbine being in contact with the combustion gas, and the heater may have the high temperature component which has steam, which is a heating target of the heater, as the second cooling medium.

In the boiler plant having the gas turbine, the compressor may have a first compression unit which is configured to compress air and a second compression unit which is further configured to compress the air compressed by the first compression unit, and the boiler plant may further include an intermediate cooler which is configured to perform heat exchange between the air compressed by the first compression unit and a third cooling medium, heat the third cooling medium while cooling the air from the first compression unit, and feed the cooled air to the second compression unit. In this case, the heater has the intermediate cooler which has steam, which is a heating target of the heater, as the third cooling medium.

In the boiler plant having the gas turbine, the boiler plant may further include a fuel preheater which is configured to heat the fuel flowing into the combustor by a steam heating medium heated by the heater.

In order to achieve the object, according to another aspect, there is provided a method for operating a boiler plant, the boiler plant includes a boiler which has one or more evaporators which is configured to heat water by a heating fluid to generate steam, a steam utilization device which is configured to use the steam from the boiler, and a connection line which connects the boiler and the steam utilization device to each other. This method includes a steam generation step of heating, by a first evaporator having a highest internal pressure from among the one or more evaporators, water having a temperature lower than a constant pressure specific heat maximum temperature, at which constant pressure specific heat in a pressure in the first evaporator is maximum, to be equal to or higher than the constant pressure specific heat maximum temperature; and a heating step of heating, by using at least energy excluding thermal energy of the heating fluid, steam having a temperature lower than the constant pressure specific heat maximum temperature from among steam in the steam utilization device, the connection line, and an intra-boiler line to be equal to or higher than the constant pressure specific heat maximum temperature.

Here, in the method for operating a boiler plant of the aspect, the heating step may include a boiler outside heating step of heating steam using only the energy excluding the thermal energy of the heating fluid.

Moreover, in the method for operating a boiler plant of the aspect, the steam utilization device may have a steam turbine, and in the heating step, exhaust steam exhausted from the steam turbine may be heated.

In the method for operating a boiler plant having the steam turbine, the steam utilization device may have a first steam turbine which is driven by steam and a second steam turbine which is driven by steam having a pressure lower than that of the first steam turbine. In this case, in the heating step, exhaust steam exhausted from the first steam turbine is heated, and the exhaust steam heated in the heating step is fed to the second steam turbine.

In the method for operating a boiler plant having the steam turbine, a reheating step of performing heat exchange between the exhaust steam exhausted from the steam turbine and the heating fluid to heat the exhaust steam may be performed. In this case, the heating step may include a boiler outside heating step of heating steam using only energy excluding thermal energy of the heating fluid. In addition, in the boiler outside heating step, the exhaust steam heated by the reheating step or the exhaust steam before being heated by the reheating step is heated.

In the method for operating a boiler plant in which the reheating step is performed, the method may include a downstream reheating step of performing heat exchange between the exhaust steam and the heating fluid on a downstream side in the flow direction of the heating fluid with respect to the first evaporator. In this case, in the boiler outside heating step, the exhaust steam heated in the downstream reheating step is heated.

In the method for operating a boiler plant in which the reheating step is performed, the reheating step may include an upstream reheating step of performing the heat exchange between the exhaust steam and the heating fluid at the same position as that of the first evaporator in the flow direction of the heating fluid or on an upstream side in the flow direction of the heating fluid with respect to the first evaporator. In this case, in the upstream reheating step, the exhaust steam heated by the boiler outside heating step is heated.

In the method for operating a boiler plant in which the upstream reheating step is performed, the heating step may include the boiler outside heating step and the upstream reheating step.

In the method for operating a boiler plant in which the boiler outside heating step is performed, the boiler outside heating step may include a plant outside heating step of heating steam using heat in other plants.

In the method for operating a boiler plant in which the boiler outside heating step is performed, the boiler plant may further include a gas turbine which has a compressor which is configured to compress air, a combustor which is configured to combust a fuel in the air compressed by the compressor to generate a combustion gas, and a turbine which is driven by the combustion gas. In this case, the boiler is an exhaust heat recovery boiler which has an exhaust gas which is a combustion gas exhausted from the turbine, as the heating fluid.

In the method for operating a boiler plant having the gas turbine, an air cooling step of performing heat exchange between a portion of high-temperature and high-pressure air compressed by the compressor and a first cooling medium so as to cool air from the compressor while heating the first cooling medium to feed cooled air to a high temperature component of the gas turbine being in contact with the combustion gas may be performed. In this case, the boiler outside heating step includes the air cooling step of having steam, which is a heating target in the boiler outside heating step, as the first cooling medium.

In the method for operating a boiler plant having the gas turbine, a high temperature component cooling step of feeding a second cooling medium to a high temperature component of the gas turbine being in contact with the combustion gas to cool the high temperature component while heating the second cooling medium may be performed. In this case, the boiler outside heating step includes the high temperature component cooling step of having steam, which is a heating target in the boiler outside heating step, as the second cooling medium.

In the method for operating a boiler plant having the gas turbine, the compressor may have a first compression unit which is configured to compress air and a second compression unit which is further configured to compress the air compressed by the first compression unit. In this case, an intermediate cooling step of performing heat exchange between the air compressed by the first compression unit and a third cooling medium, heating the third cooling medium while cooling the air from the first compression unit, and feeding the cooled air to the second compression unit may be performed. The boiler outside heating step includes the intermediate cooling step having steam, which is a heating target in the boiler outside heating step, as the third cooling medium.

In the method for operating a boiler plant having the gas turbine, a fuel preheating step of heating the fuel flowing into the combustor by the steam heated in the boiler outside heating step.

### Effects of the Invention

In an aspect of the present invention, it is possible to effectively use heat of a heating fluid flowing through a boiler.

### BRIEF DESCRIPTION OF THE DRAWINGS

FIG. 1 is a system diagram of a boiler plant in a first embodiment according to the present invention.

FIG. 2 is a system diagram of a boiler plant in a second embodiment according to the present invention.

FIG. 3 is a system diagram of a boiler plant in a third embodiment according to the present invention.

FIG. 4 is a system diagram of a boiler plant in a fourth embodiment according to the present invention.

FIG. 5 is a system diagram of a boiler plant in a fifth embodiment according to the present invention.

FIG. 6 is a system diagram of a boiler plant in a sixth embodiment according to the present invention.

FIG. 7 is a system diagram of a boiler plant in a seventh embodiment according to the present invention.

FIG. 8 is a system diagram of a boiler plant in an eighth embodiment according to the present invention.

FIG. 9 is a system diagram of a boiler plant in a ninth embodiment according to the present invention.

FIG. 10 is a system diagram of a boiler plant in a tenth embodiment according to the present invention.

FIG. 11 is a system diagram of a boiler plant in an eleventh embodiment according to the present invention.

FIG. 12 is a system diagram of a boiler plant in a twelfth embodiment according to the present invention.

FIG. 13 is an explanatory diagram showing a plant in which a heater of a first modification example according to the present invention is disposed.

FIG. 14 is an explanatory diagram showing a plant in which a heater of a second modification example according to the present invention is disposed.

FIG. 15 is an explanatory diagram showing a plant in which a heater of a third modification example according to the present invention is disposed.

FIG. 16 is an explanatory diagram showing a plant in which a heater of a fourth modification example according to the present invention is disposed.

FIG. 17 is an explanatory diagram showing a plant in which a heater of a fifth modification example according to the present invention is disposed.

FIG. 18 is a graph showing a relationship between a temperature and a constant pressure specific heat of water.

### EMBODIMENTS OF THE INVENTION

Hereinafter, various embodiments and modification examples of a boiler plant according to the present invention will be described with reference to the drawings.

### First Embodiment of Boiler Plant

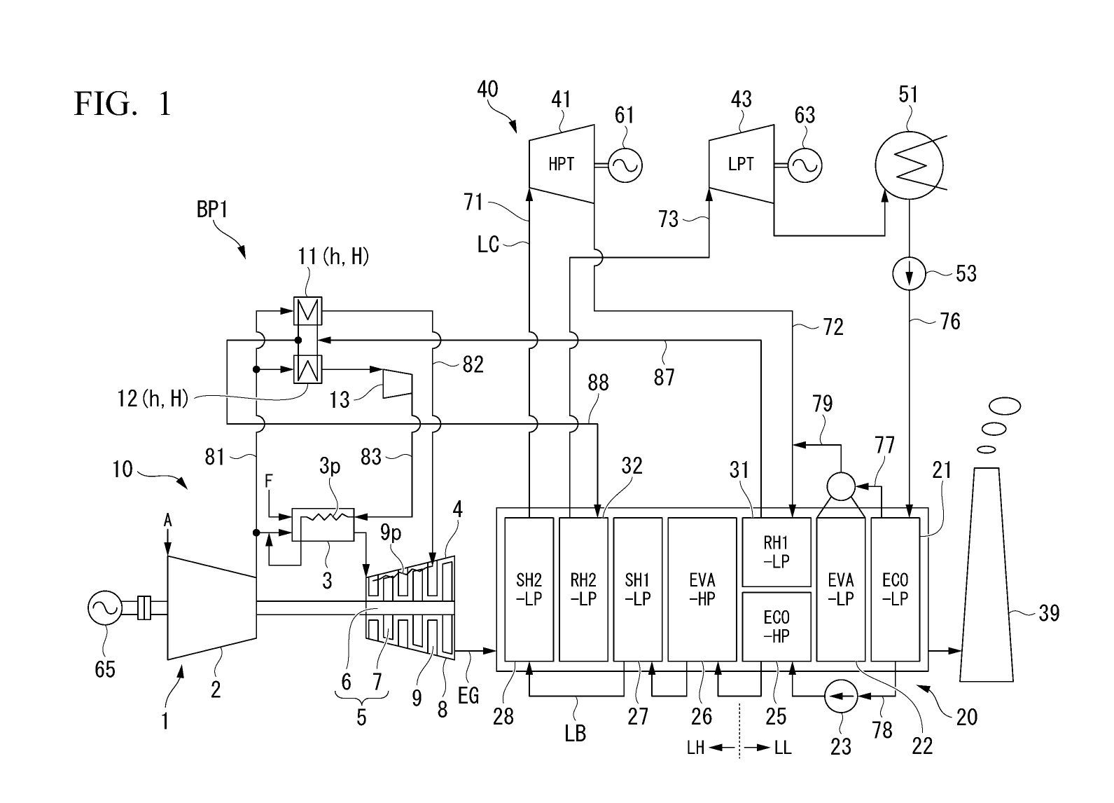

A first embodiment of the boiler plant of the present invention will be described with reference to FIG. 1.

As shown in FIG. 1, a boiler plant BP1 of the present embodiment includes gas turbine equipment 10, an exhaust heat recovery boiler 20, steam turbine equipment 40, and a stack 39. In addition, like this boiler brand, a plant including the gas turbine equipment, the exhaust heat recovery boiler, and the steam turbine equipment is generally referred to as a combined cycle plant.

The gas turbine equipment includes a gas turbine 1, a first air cooler 11 and a second air cooler 12 which cool air, and a boost compressor 13. The gas turbine 1 includes an air compressor 2 which compresses air A, a combustor 3 which combusts a fuel F in the air compressed by the air compressor 2 so as to generate a combustion gas, and a turbine 4 which is driven by a high temperature and high pressure combustion gas. The turbine 4 includes a turbine rotor 5, a turbine casing 8 which covers the turbine rotor 5, and a plurality of vanes 9. The turbine rotor 5 has a rotor shaft 6, and a plurality of blades 7 which are attached to an outer periphery of the rotor shaft 6. The plurality of vanes 9 are disposed inside the turbine casing 8 and are fixed to the turbine casing 8. In a plurality of components constituting the gas turbine 1, components such as the combustor 3, the vane 9 of the turbine 4, the blade 7 of the turbine 4, and a ring segment constituting a portion of an inner peripheral surface of the turbine casing 8 are high temperature components which are in contact with the high temperature and high pressure combustion gas. In the high temperature components, cooling air passages (medium passages) 3p and 9p through which air (cooling medium) passes are formed. Each of the cooling air passages (medium passages) 3p and 9p has an air inlet into which the air flows and an outlet through which the air is discharged to the combustion gas or a compressed air. The turbine rotor 5 of the turbine 4 and a compressor rotor of the air compressor 2 are connected to each other and constitute a gas turbine rotor. For example, a generator rotor of a generator 65 is connected to the gas turbine rotor. The combustion gas exhausted from the turbine 4 is supplied to the exhaust heat recovery boiler 20, as an exhaust gas EG.

The first air cooler 11 cools a portion of air discharged from the air compressor 2, and for example, feeds this air to the vane 9 which is one of the high temperature components. The second air cooler 12 cools a portion of the air discharged from the air compressor 2. The boost compressor 13 boosts the air cooled by the second air cooler 12, and for example, feeds this air to the combustor 3 which is one of the high temperature components. The air compressor 2, an air inlet of the first air cooler 11, and an air inlet of the second air cooler 12 are connected to each other by a compression air line 81. An air outlet of the first air cooler 11 and an air inlet in the cooling air passage (medium passage) 9p of the vane 9 are connected to each other by a first cooling air line 82. An air outlet of the second air cooler 12 and an air inlet in the cooling air passage (medium passage) 3p of the combustor 3 are connected to each other by a second cooling air line 83. The boost compressor 13 is provided in the second cooling air line 83.

The steam turbine equipment 40 includes a high pressure steam turbine 41 and a low pressure steam turbine 43 which are driven by the steam generated by the exhaust heat recovery boiler 20, a condenser 51 which returns the steam exhausted from the low pressure steam turbine 43 to water, and a water supply pump 53 which returns the water in the condenser 51 to the exhaust heat recovery boiler 20. Rotors of generators 61 and 63 are connected to a turbine rotor of the high pressure steam turbine 41 and a turbine rotor of the low pressure steam turbine 43, respectively. Both the high pressure steam turbine 41 and the low pressure steam turbine 43 are steam utilization devices which use the steam generated in the exhaust heat recovery boiler 20.

The exhaust heat recovery boiler 20 generates steam using the heat of the exhaust gas (heating fluid) EG from the gas turbine 1. The exhaust heat recovery boiler 20 has a low pressure economizer (ECO-LP) 21 which heats the water fed by the water supply pump 53, a low pressure evaporator (EVA-LP) 22 which evaporates the water heated by the low pressure economizer 21, a high pressure pump 23 which boosts the water heated by the low pressure economizer 21, a high pressure economizer (ECO-HP) 25 which heats a high pressure water which is the water boosted by the high pressure pump 23, a high pressure evaporator (EVA-HP) 26 which evaporates the high pressure water heated by the high pressure economizer 25, a first high pressure superheater (SH1-HP) 27 which superheats the steam generated by the high pressure evaporator 26, a second high pressure superheater (SH2-HP) 28 which further superheats the steam superheated by the first high pressure superheater 27 to generate high pressure steam, a first reheater (RH1-LP) 31 which heats the steam exhausted from the high pressure steam turbine 41, and a third reheater (RH2-LP) 32 which heats the steam heated by the first reheater (RH1-LP) 31.

In a flow direction of the exhaust gas EG flowing through the exhaust heat recovery boiler 20, based on the gas turbine 1, a side on which the stack 39 exists is referred to a downstream side and a side opposite to the downstream side is referred to as an upstream side. The low pressure economizer 21, the low pressure evaporator 22, the first reheater 31, the high pressure economizer 25, the high pressure evaporator 26, the first high pressure superheater 27, the second reheater 32, and the second high pressure superheater 28 are disposed in this order from the downstream side of the exhaust heat recovery boiler 20 toward the upstream side thereof. In addition, in the present embodiment, a position of the first reheater 31 and a position of the high pressure economizer 25 are substantially the same as each other in the flow direction of the exhaust gas EG.

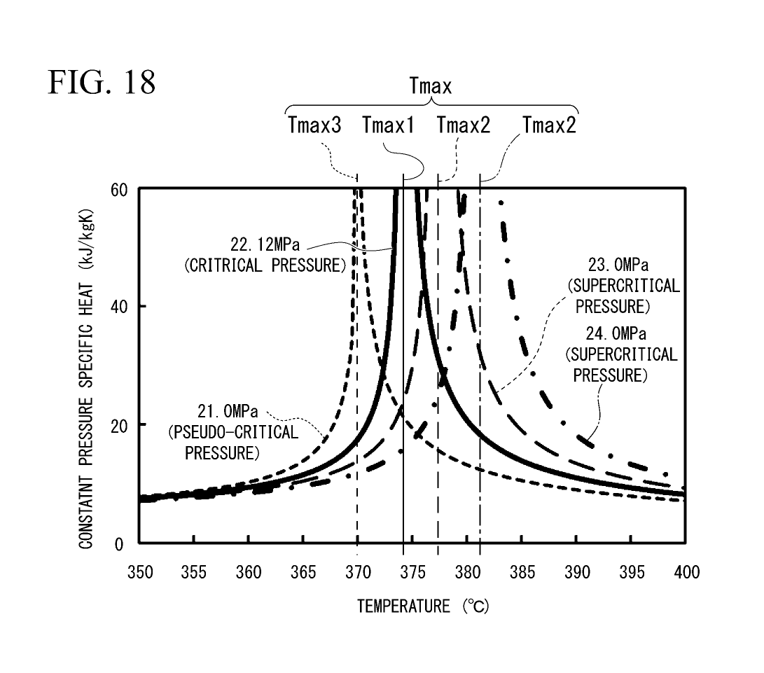

Each of the low pressure evaporator 22 and the high pressure evaporator 26 is a device which heats water having a temperature lower than a constant pressure specific heat maximum temperature Tmax, at which a constant pressure specific heat in an internal pressure is maximum, to be equal to or higher than the constant pressure specific heat maximum temperature Tmax. For example, specifically, as shown in FIG. 18, in a case where a pressure of the water heated by the high pressure evaporator 26 is a critical pressure, the high pressure evaporator 26 is a device which heats water having a temperature lower than a temperature at which the constant pressure specific heat at the critical pressure is maximum, that is, water having a temperature lower than a critical temperature Tmax1 (constant pressure specific heat maximum temperature Tmax) to water having a temperature equal to or higher than the critical temperature Tmax1. In a case where the pressure of the water heated by the high pressure evaporator 26 is higher than the critical pressure, the high pressure evaporator 26 is a device which heats water having a temperature lower than a temperature at which the constant pressure specific heat in the pressure of the water heated by the high pressure evaporator 26 is maximum, that is, water having a temperature lower than a pseudo-critical temperature Tmax2 (constant pressure specific heat maximum temperature Tmax) to water having a temperature equal to or higher than the pseudo-critical temperature Tmax2. In a case where the pressure of the water heated by the high pressure evaporator 26 is lower than the critical pressure, the high pressure evaporator 26 is a device which heats water having a temperature lower than a temperature at which the constant pressure specific heat in the pressure of the water heated by the high pressure evaporator 26 is maximum, that is, water having a temperature lower than a saturation temperature Tmax3 (constant pressure specific heat maximum temperature Tmax) to water having a temperature equal to or higher than the saturation temperature Tmax3. Accordingly, in the following descriptions, the steam generated by the high pressure evaporator 26 refers to a fluid in which the water having a temperature lower than the critical temperature Tmax1 become the water having a temperature equal to or higher than the critical temperature Tmax1 in the critical pressure, a fluid in which the water having a temperature lower than the pseudo-critical temperature Tmax2 become the water having a temperature equal to or higher than the pseudo-critical temperature Tmax2 in a supercritical pressure, or a fluid in which the water having a temperature lower than the saturation temperature Tmax3 become the water having a temperature equal to or higher than the saturation temperature Tmax3 in a subcritical pressure. In addition, the high pressure pump 23 is a pump which boosts the pressure of the water heated by the low pressure economizer 21 to the critical pressure, the supercritical pressure, and the subcritical pressure. Here, the pseudo-critical temperature Tmax2 and the saturation temperature Tmax3 shown in FIG. 18 are examples, and it should be noted that the pseudo-critical temperature Tmax2 and the saturation temperature Tmax3 is changed by the pressure of the water heated by the high pressure evaporator 26. In addition, here, a case where the constant pressure specific heat is infinite will be referred to as the maximum.

The condenser 51 and the low pressure economizer 21 are connected to each other by a water supply line 76. The above-described water supply pump 53 is provided in the water supply line 76. A first low pressure water line 77 through which the water heated by the low pressure economizer 21 is fed to the low pressure evaporator 22 and a second low pressure water line 78 through which the water heated by the low pressure economizer 21 is fed to the high pressure economizer 25 are connected to the low pressure economizer 21. The above-described high pressure pump 23 is provided in the second low pressure water line 78. A steam outlet of the high pressure superheater 27 and a steam inlet of the high pressure steam turbine 41 are connected to each other by a high pressure steam supply line 71 through which the steam superheated by the high pressure superheater 27 is supplied to the high pressure steam turbine 41. In addition, a steam outlet of the high pressure steam turbine 41 and a steam inlet of the first reheater 31 are connected to each other by a high pressure steam recovery line 72. A low pressure steam line 79 through which the steam generated by the low pressure evaporator 22 is fed to the first reheater 31 is connected to the high pressure steam recovery line 72. A steam outlet of the first reheater 31, a steam inlet of the first air cooler 11, and a steam inlet of the second air cooler 12 are connected to each other by a before-heating reheat steam line (before-heating line) 87. A steam outlet of the first air cooler 11, a steam outlet of the second air cooler 12, and a steam inlet of the second reheater 32 are connected to each other by an after-heating reheat steam line (after-heating line) 88. A steam outlet of the second reheater 32 and a steam inlet of the low pressure steam turbine 43 are connected to each other by a reheated steam supply line 73 through which the steam heated by the second reheater 32 is supplied to the low pressure steam turbine 43. A steam outlet of the low pressure steam turbine 43 and the condenser 51 are connected to each other such that the steam exhausted from the low pressure steam turbine 43 is supplied to the condenser 51.

The high pressure steam supply line 71, the high pressure steam recovery line 72, and the reheated steam supply line 73 constitute a connection line LC which connects any steam turbine and the exhaust heat recovery boiler 20 to each other. The device such as the low pressure economizer 21 included in the exhaust heat recovery boiler 20 and the lines which connect a plurality of devices included in the exhaust heat recovery boiler 20 to each other constitute an intra-boiler line LB. The high pressure steam recovery line 72 in the connection line LC is a low temperature portion LL through which exhaust steam having a temperature lower than the constant pressure specific heat maximum temperature Tmax, at which the constant pressure specific heat at the pressure in the high pressure evaporator 26 is maximum, flows. Moreover, in the intra-boiler line LB, a line on the downstream side of the high pressure evaporator 26 in the flow of the exhaust gas is the low temperature portion LL through which steam or water having the temperature lower than the constant pressure specific heat maximum temperature Tmax flows. Meanwhile, the high pressure steam supply line 71 and the reheated steam supply line 73 in the connection line LC are high temperature portions through which the steam having a temperature equal to or higher than the constant pressure specific heat maximum temperature Tmax flows in the high pressure evaporator 26. In the intra-boiler line LB, the high pressure evaporator 26 and a line on the upstream side of the high pressure evaporator 26 in the flow of the exhaust gas EG are high temperature portions LH through which the steam or water having the temperature equal to or higher than the constant pressure specific heat maximum temperature Tmax flows.

Each of the first air cooler 11 and the second air cooler 12 is a heat exchanger which performs heat exchange between the air discharged from the air compressor 2 and the steam (first cooling medium) from the first reheater 31 and heats the steam while cooling the air. Accordingly, each of the first air cooler 11 and the second air cooler 12 is also a heater h which heats the steam.

Next, an operation of the above-described boiler plant BP1 will be described.

The air compressor 2 of the gas turbine 1 compresses air A in the atmosphere and supplies the compressed air A to the combustor 3. In addition, a fuel F from a fuel supply source is supplied to the combustor 3. In the combustor 3, the fuel F is combusted in the compressed air A, and thus, the high temperature and high pressure combustion gas is generated. This combustion gas is fed to the turbine 4, and thus, rotates the turbine rotor 5 of the turbine 4. The generator 65 which is connected to the gas turbine 1 generates electricity by the rotation of the turbine rotor 5.

If the high temperature combustion gas is generated in the combustor 3, the high temperature component such as the combustor 3 or the blade 7 and the vane 9 of the turbine 4 is heated by the combustion gas.

A portion of the air discharged from the air compressor 2 flows into the first air cooler 11 and the second air cooler 12 via the compression air line 81. In the first air cooler 11 and the second air cooler 12, the air and the steam from the first reheater 31 are heat-exchanged with each other, and thus, the steam is heated (heating step, boiler outside heating step) while the air is cooled (air cooling step). The air cooled by the first air cooler 11 is supplied into the cooling air passage 9p of the vane 9 via the first cooling air line 82 to cool the vane 9. Moreover, the air cooled by the second air cooler 12 is boosted by the boost compressor 13, and thereafter, is supplied into the cooling air passage 3p of the combustor 3 via the second cooling air line 83 to cool the combustor 3.

The combustion gas which has rotate the turbine rotor 5 of the turbine 4 is exhausted from the gas turbine 1 as the exhaust gas EG. The exhaust gas EG passes through the exhaust heat recovery boiler 20, and thereafter, is exhausted to the atmosphere from the stack 39. The exhaust heat recovery boiler 20 generates steam from water using heat of the exhaust gas EG.

In the exhaust heat recovery boiler 20, the water from the condenser 51 is supplied to the low pressure economizer 21 on the most downstream side via the water supply line 76. The low pressure economizer 21 performs heat exchange between this water and the exhaust gas EG so as to heat the water. A portion of the water heated by the low pressure economizer 21 is fed to the low pressure evaporator 22 via the first low pressure water line 77, and is further heated in the low pressure evaporator 22 so as to be steam. This steam is fed to the first reheater 31 via the low pressure steam line 79 and the high pressure steam recovery line 72. In addition, the remaining water heated by the low pressure economizer 21 is boosted by the high pressure pump 23, and thereafter, is fed to the high pressure economizer 25. The high pressure economizer 25 performs heat exchange between this water and the exhaust gas EG so as to heat the water. The water heated by the high pressure economizer 25 is further heated by the high pressure evaporator 26 so as to be steam (steam generation step). This steam is further superheated by the first high pressure superheater 27. The steam superheated by the first high pressure superheater 27 is superheated by the second high pressure superheater 28. This steam is supplied to the high pressure steam turbine (first steam turbine) 41 via the high pressure steam supply line 71.

The steam supplied to the high pressure steam turbine 41 rotates the turbine rotor of the high pressure steam turbine 41. The generator 61, which is connected to the high pressure steam turbine 41, generates electricity by the rotation of the turbine rotor. The high pressure steam which has passed through the high pressure steam turbine 41 (first steam turbine) is fed to the first reheater 31 via the high pressure steam recovery line 72. In addition, as described above, the steam generated by the low pressure evaporator 22 is fed to the first reheater 31 via the low pressure steam line 79 and the high pressure steam recovery line 72. That is, the high pressure steam which has passed through the high pressure steam turbine 41 and the steam which is generated by the low pressure evaporator 22 are combined with each other and flow into the first reheater 31. This steam is heated to a temperature lower than the constant pressure specific heat maximum temperature Tmax in the high pressure evaporator 26, by the first reheater 31.

The steam reheated by the first reheater 31 flows into the first air cooler 11 and the second air cooler 12 via the before-heating reheat steam line (before-heating line) 87. The steam (first cooling medium) which has flowed into the first air cooler 11 (heater h) and the second air cooler 12 (heater h) is heat-exchanged with the air from the air compressor 2, and is heated to a temperature equal to or higher than the constant pressure specific heat maximum temperature Tmax in the high pressure evaporator 26 (heating step, boiler outside heating step). Accordingly, each of the first air cooler 11 (heater h) and the second air cooler 12 (heater h) is a heating device H which heats the steam or water having the temperature lower than the constant pressure specific heat maximum temperature Tmax in the high pressure evaporator 26 to the steam or water having the temperature equal to or higher than the constant pressure specific heat maximum temperature Tmax at the high pressure evaporator 26. The steam heated by the first air cooler 11 and the second air cooler 12 flows into the second reheater 32 via the after-heating reheat steam line (after-heating line) 88. The steam which has flowed into the second reheater 32 is further heated by the second reheater 32 (reheating step, upstream reheating step). This steam is supplied to the low pressure steam turbine (second steam turbine) 43 via the reheated steam supply line 73.

The steam supplied to the low pressure steam turbine 43 rotates the turbine rotor of the low pressure steam turbine 43. The generator 63, which is connected to the low pressure steam turbine 43, generates electricity by the rotation of the turbine rotor. The steam, which has passed through the low pressure steam turbine 43, flows into the condenser 51 and is returned to water by the condenser 51. As described above, the water in the condenser 51 is supplied to the low pressure economizer 21 by the water supply pump 53.

When the steam passes through a steam turbine group which is a collection of the plurality of steam turbines 41 and 43, as an energy drop of the steam increases, an output obtained from the entire steam turbine group increases. In the steam turbine equipment 40, the steam exhausted from the plurality of steam turbines 41 and 43 is finally returned to the water by the condenser 51, and thereafter, is returned to the exhaust heat recovery boiler 20. A temperature and a pressure of the steam flowing into the condenser 51 is necessarily determined by a temperature of the water or the like which cools the steam in the condenser 51. The steam generated by the high pressure evaporator 26 has a highest pressure and is expanded at a large pressure ratio up to the condenser 51, and the output can be extracted with a largest energy drop. That is, a value of the steam generated in the high pressure evaporator 26 is higher than a value of the steam generated in another evaporator 22. Accordingly, increasing a flow rate of the steam generated in the high pressure evaporator 26 is extremely important to increase the output and efficiency of the steam turbine equipment 40.

The high pressure evaporator 26 heats the water or steam having the temperature lower than the constant pressure specific heat maximum temperature Tmax, at which the constant pressure specific heat at the pressure in the high pressure evaporator 26 is maximum, to be equal to or higher than the constant pressure specific heat maximum temperature Tmax. A specific heat of the fluid at a temperature near this maximum temperature Tmax is large. Accordingly, in the high pressure evaporator 26, lots of heat is required to increase a temperature. The flow rate of the steam which can be generated by the high pressure evaporator 26 is determined by a heat quantity at a temperature level near the constant pressure specific heat maximum temperature Tmax which is available in the high pressure evaporator 26. Therefore, in order to increase the output and efficiency of the steam turbine equipment 40, it is extremely important to increase the steam flow rate generated by the high pressure evaporator 26 by inputting lots of heat having the temperature level near the constant pressure specific heat maximum temperature Tmax to the high pressure evaporator 26 so as to increase the flow rate of the steam generated by the high pressure evaporator 26.

In the present embodiment, the steam or water which flows through the low temperature portion LL in the connection line LC and the intra-boiler line LB and has the temperature lower than the constant pressure specific heat maximum temperature Tmax is heated to be equal to or higher than the constant pressure specific heat maximum temperature Tmax by the first air cooler 11 (heater h) and the second air cooler 12 (heater h), and thereafter, is returned to the second reheater 32 positioned on the upstream side of the high pressure evaporator 26. For this reason, a heat quantity of the temperature level near the constant pressure specific heat maximum temperature Tmax which can be consumed by the high pressure evaporator 26 out of a heat quantity of the exhaust gas increases. Accordingly, the flow rate of the steam generated by the high pressure evaporator 26 increases, and thus, it is possible to increase the output and efficiency of the steam turbine equipment 40. That is, in the present embodiment, the heat of the temperature level the near constant pressure specific heat maximum temperature Tmax out of the heat of the exhaust gas (heating fluid) HG can be effectively used by the high pressure evaporator 26.

The boiler plant BP1 of the present embodiment has the first reheater 31 disposed on the downstream side (downstream side in the flow of the exhaust gas EG) of the high pressure evaporator 26 and the second reheater 32 which is disposed on the upstream side (upstream side in the flow of the exhaust gas EG) of the high pressure evaporator 26, and the steam heated by the first reheater 31 is fed to the second reheater 32. In the above-described configuration of the present embodiment, the heat quantity required when the steam is generated in the high pressure evaporator 26 is large, and thus, a temperature drop of the exhaust gas before and after the high pressure evaporator 26 becomes large. Accordingly, the temperature of the exhaust gas in the first reheater 31 is significantly lower than the temperature of the exhaust gas in the second reheater 32. If a case where the configuration of the present embodiment is not applied is considered, that is, if a case where the steam heated by the first reheater 31 is directly fed to the second reheater 32 is considered, a temperature relationship of each location is as follows.

(Exhaust Gas Outlet Temperature of Second reheater 32)>>(Exhaust Gas Inlet Temperature of First Reheater 31)>(Steam outlet Temperature of First Reheater 31)=(Steam inlet Temperature of Second Reheater 32)

The steam outlet temperature of the first reheater 31, that is, the steam inlet temperature of the second reheater 32 is significantly lower than the temperature of the exhaust gas in the second reheater 32. Accordingly, a temperature difference between the exhaust gas and the steam in the second reheater 32 is large, and thus, it is not possible to effectively recover the heat of the high temperature exhaust gas by the steam. Meanwhile, as in the present embodiment, if the steam between the first reheater 31 and the second reheater 32 is heated using the heat (here, the exhaust heat of the air cooler) from the outside excluding the heat energy of the exhaust gas, the temperature at the steam inlet in the second reheater 32 increases, and thus, it is possible to significantly decrease the temperature difference between the exhaust gas and the steam in the second reheater 32. Accordingly, it is possible to fully use the heat of the high temperature exhaust gas flowing through the second reheater 32, and particularly, a large heat utilization efficiency improvement effect can be obtained.

In the present embodiment, the heating device is configured, which heats the water or steam by only the first air cooler 11 (heater h) and the second air cooler 12 (heater h). That is, in the present embodiment, the water or steam is heated to be equal to or higher than the constant pressure specific heat maximum temperature Tmax by only the heater h. In this configuration, it is possible to most effectively increase the flow rate of the steam generated by the high pressure evaporator 26, an effect enhancing the output and efficiency of the steam turbine equipment 40 is large, and the configuration is most preferable. However, in a case where the exhaust heat quantity of the first air cooler 11 (heater h) and the second air cooler 12 (heater h) is insufficient, a heating device may be configuration, which includes a reheater (for example, the second reheater 32 of the present embodiment) heating the steam using the heat of the exhaust gas in addition to the first air cooler 11 (heater h) and the second air cooler 12 (heater h). That is, in the outlets of the first air cooler 11 (heater h) and the second air cooler 12 (heater h), the temperature of the steam is lower than the constant pressure specific heat maximum temperature Tmax at which the constant pressure specific heat at the pressure in the high pressure evaporator 26 is maximum, and the steam in the reheater is heated to be equal to or higher than the constant pressure specific heat maximum temperature Tmax at which the constant pressure specific heat at the pressure in the high pressure evaporator 26 is maximum. Therefore, even when the heating device is configured in this manner, the water or steam lower than the constant pressure specific heat maximum temperature Tmax at which the constant pressure specific heat at the pressure in the high pressure evaporator 26 is maximum can be heated to be equal to or higher than the constant pressure specific heat maximum temperature Tmax at which the constant pressure specific heat at the pressure in the high pressure evaporator 26 is maximum, by the heating device. In this case, even when the exhaust heat quantities of the first air cooler 11 (heater h) and the second air cooler 12 (heater h) are insufficient, it is possible to increase a generation amount of the steam in the high pressure evaporator 26 and to increase the output and efficiency of the steam turbine equipment 40. In this way, various configurations can be taken depending on the heat quantity obtained by the heater h, as in exemply embodiments below.

Moreover, in the present embodiment, the steam or water flowing through the low temperature portion LL is set to a heat source which is heated by the first air cooler 11 (heater h) and the second air cooler 12 (heater h), the exhaust heat (excluding the exhaust gas EG) of the gas turbine equipment 10 is used, and thus, it is possible to suppress an energy cost for obtaining the heat source.

### Second Embodiment of Boiler Plant

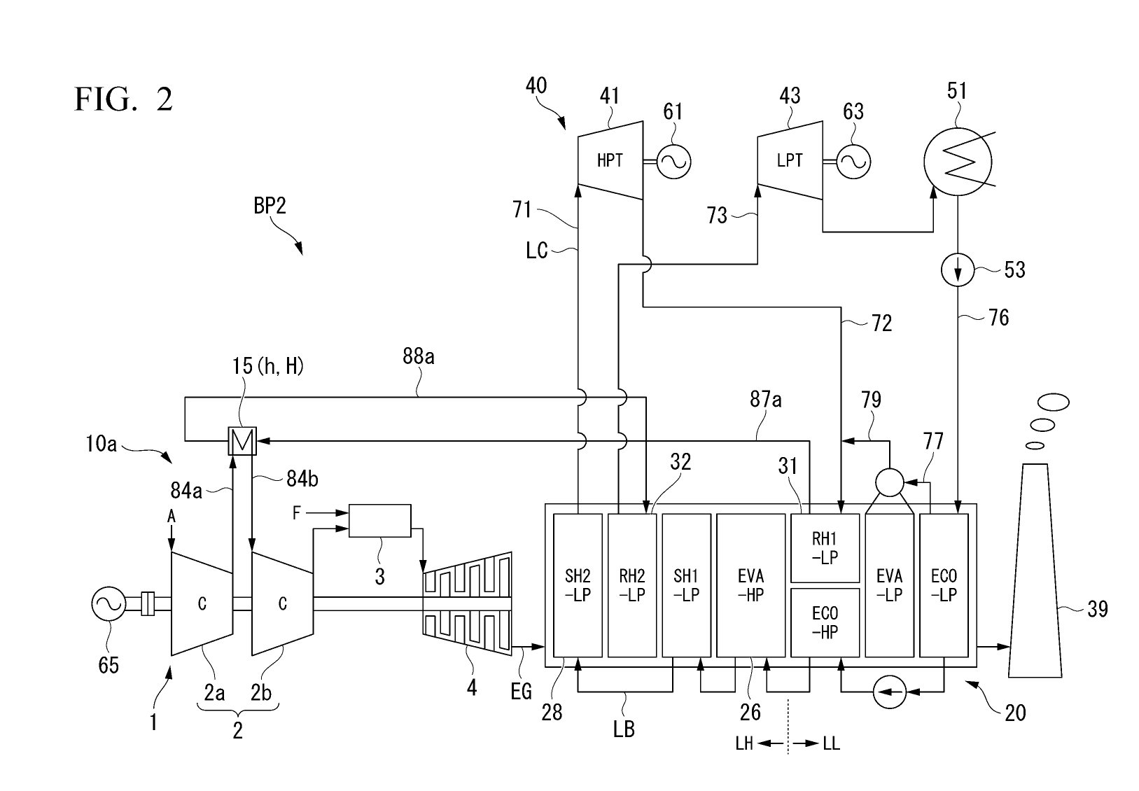

A second embodiment of the boiler plant according to the present invention will be described with reference to FIG. 2.

Similarly to the first embodiment, a boiler plant BP2 of the present embodiment includes gas turbine equipment 10a, the exhaust heat recovery boiler 20, the steam turbine equipment 40, and the stack 39. The exhaust heat recovery boiler 20 of the present embodiment is the same as the exhaust heat recovery boiler 20 of the first embodiment. The steam turbine equipment 40 of the present embodiment is the same as the steam turbine equipment 40 of the first embodiment. However, the gas turbine equipment 10a of the present embodiment is different from the gas turbine equipment 10 of the first embodiment.

The gas turbine equipment 10a of the present embodiment includes the gas turbine 1 and an intermediate cooler 15. Similarly to the first embodiment, the gas turbine 1 of the present embodiment includes the air compressor 2, the combustor 3, and the turbine 4. The air compressor 2 has a first compression unit 2a which compresses air and a second compression unit 2b which further compresses the air compressed by the first compression unit 2a. The air compressed by the second compression unit 2b is supplied to the combustor 3 or the like.

The intermediate cooler 15 cools the air compressed by the first compression unit 2a and feeds the cooled air to the second compression unit 2b. An air discharge port of the first compression unit 2a and an air inlet of the intermediate cooler 15 are connected to each other by a first intermediate compression air line 84a. An air outlet of the intermediate cooler 15 and an air inlet of the second compression unit 2b are connected to each other by a second intermediate compression air line 84b. An air outlet of the second compression unit 2b is connected to the combustor 3 or the like.

The steam outlet of the first reheater 31 and a steam inlet of the intermediate cooler 15 are connected to each other by a before-heating reheat steam line 87a. The steam outlet of the intermediate cooler 15 and the steam inlet of the second reheater 32 are connected to each other by an after-heating reheat steam line 88a. The intermediate cooler 15 performs heat exchange between the air compressed by the first compression unit 2a and the steam (third cooling medium) from the first reheater 31, and heats the steam (third cooling medium) from the first reheater 31 to be equal to or higher than the constant pressure specific heat maximum temperature Tmax in the high pressure evaporator 26 (heating step, boiler outside heating step) while the cooling the air from the first compression unit 2a (intermediate cooling step). Accordingly, the intermediate cooler 15 is the heater h which heats the steam and is also a heating device H. In addition, in the present specification, the heater h is a device which heats the steam or water by energy excluding thermal energy of the exhaust gas (heating fluid) HG In addition, in the present specification, the heating device H has the heater h and a device which heats the steam or water lower than the constant pressure specific heat maximum temperature Tmax in the high pressure evaporator 26 to be equal to or higher than the constant pressure specific heat maximum temperature Tmax in the high pressure evaporator 26.

Also in the present embodiment, the steam or water which flows through the low temperature portion LL in the connection line LC and the intra-boiler line LB and has the temperature lower than the constant pressure specific heat maximum temperature Tmax is heated to be equal to or higher than the constant pressure specific heat maximum temperature Tmax by the intermediate cooler 15 (heater h), and thereafter, is returned to the second reheater 32 positioned on the upstream side of the high pressure evaporator 26. Accordingly, also in the present embodiment, the flow rate of the steam generated by the high pressure evaporator 26 increases, and thus, it is possible to increase the output and efficiency of the steam turbine equipment 40. That is, also in the present embodiment, the heat of the temperature level near the constant pressure specific heat maximum temperature Tmax out of the heat of the exhaust gas EG can be effectively used by the high pressure evaporator 26.

Moreover, in the present embodiment, the steam or water flowing through the low temperature portion LL is set to a heat source which is heated by the intermediate cooler 15 (heater h), the exhaust heat (excluding the exhaust gas EG) of the gas turbine equipment 10a is used, and thus, it is possible to suppress the energy cost for obtaining the heat source.

Moreover, in the present embodiment, the air from the first compression unit 2a of the air compressor 2 is cooled, and thereafter, the air is fed to the second compression unit 2b. Accordingly, it is possible to decrease compression power in the air compressor 2, and it is possible to increase the output of the gas turbine 1.

### Third Embodiment of Boiler Plant

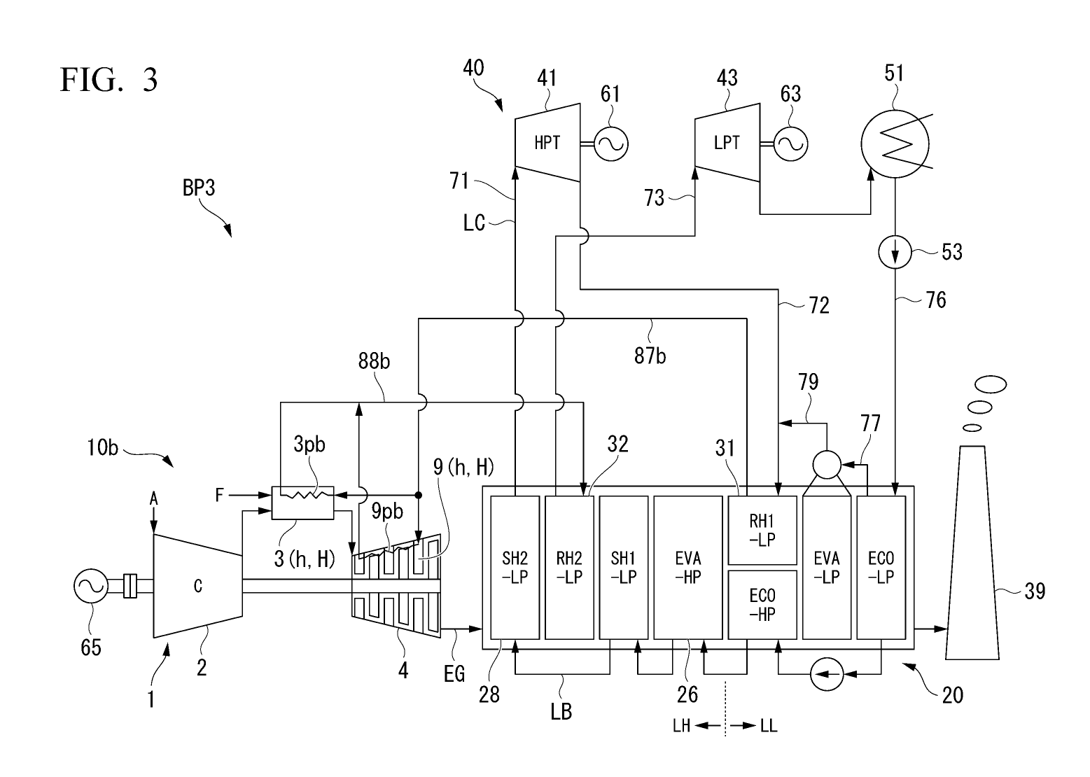

A third embodiment of the boiler plant according to the present invention will be described with reference to FIG. 3.

Similarly the above-described embodiments, a boiler plant BP3 of the present embodiment includes gas turbine equipment 10b, the exhaust heat recovery boiler 20, the steam turbine equipment 40, and the stack 39. The exhaust heat recovery boiler 20 of the present embodiment is the same as the exhaust heat recovery boiler 20 of the first embodiment. The steam turbine equipment 40 of the present embodiment is the same as the steam turbine equipment 40 of the first embodiment. However, the gas turbine equipment 10b of the present embodiment is different from the gas turbine equipment 10 of the first embodiment.

The gas turbine equipment 10b of the present embodiment includes the gas turbine 1. Similarly to the first embodiment, the gas turbine 1 of the present embodiment includes the air compressor 2, the combustor 3, and the turbine 4. As described above, the combustor 3, the vane 9 of the turbine 4, or the like of the present embodiment is the high temperature component which is in contact with a high temperature and high pressure combustion gas. Steam passages (medium passage) 3pb and 9pb through which the steam serving as the cooling medium passes are formed in the combustor 3 and the vane 9, respectively. Each of the steam passages (medium passages) 3pb and 9pb has a steam inlet into which the steam flows and a steam outlet from which the steam flows.

The steam outlet of the first reheater 31 and the steam inlet in the steam passage 3pb of the combustor 3 are connected to each other by a before-heating reheat steam line 87b. In addition, the before-reheating reheat steam line 87b connects the steam outlet of the first reheater 31 and the steam line in the steam passage 9pb of the vane 9 to each other. The steam outlet in the steam passage 3pb of the combustor 3 and the steam inlet of the second reheater 32 are connected to each other by an after-heating reheat steam line 88b. The after-heating reheat steam line 88b connects the steam outlet in the steam passage 9pb of the vane 9 and the steam inlet of the second reheater 32 to each other. While the combustor 3 performs heat exchange between the steam (second cooling medium) from the first reheater 31 and the combustor 3 so as to cool the combustor 3 (high temperature component cooling step), the combustor 3 heats the steam (second cooling medium) from the first reheater 31 to be equal to or higher than the constant pressure specific heat maximum temperature Tmax in the high pressure evaporator 26. In addition, while the vane 9 performs heat exchange between the steam (second cooling medium) from the first reheater 31 and the vane 9 so as to cool the vane 9 (high temperature component cooling step), the vane 9 heats the steam (second cooling medium) from the first reheater 31 to be equal to or higher than the constant pressure specific heat maximum temperature Tmax in the high pressure evaporator 26. Accordingly, the high temperature component such as the combustor 3 or the vane 9 is the heater h which heats the steam and is also the heating device H.

Also in the present embodiment, the steam or water which flows through the low temperature portion LL in the connection line LC and the intra-boiler line LB and has the temperature lower than the constant pressure specific heat maximum temperature Tmax is heated to be equal to or higher than the constant pressure specific heat maximum temperature Tmax by the high temperature component (heater h), and thereafter, is returned to the second reheater 32 positioned on the upstream side of the high pressure evaporator 26. Accordingly, also in the present embodiment, the flow rate of the steam generated by the high pressure evaporator 26 increases, and thus, it is possible to increase the output and efficiency of the steam turbine equipment 40. That is, also in the present embodiment, the heat of the temperature level near the constant pressure specific heat maximum temperature Tmax out of the heat of the exhaust gas EG can be effectively used by the high pressure evaporator 26.

Moreover, in the present embodiment, the steam or water flowing through the low temperature portion LL is set to a heat source which is heated by the high temperature component (heater h), the exhaust heat (excluding the exhaust gas EG) of the gas turbine equipment 10b is used, and thus, it is possible to reduce the energy cost for obtaining the heat source.

In addition, in the present embodiment, the steam or water flowing through the low temperature portion LL is heated by the heat of the high temperature component which is in contact with the combustion gas having an extremely high temperature, and thus, it is possible to effectively heat the steam or water from the low temperature portion LL.

### Fourth Embodiment of Boiler Plant

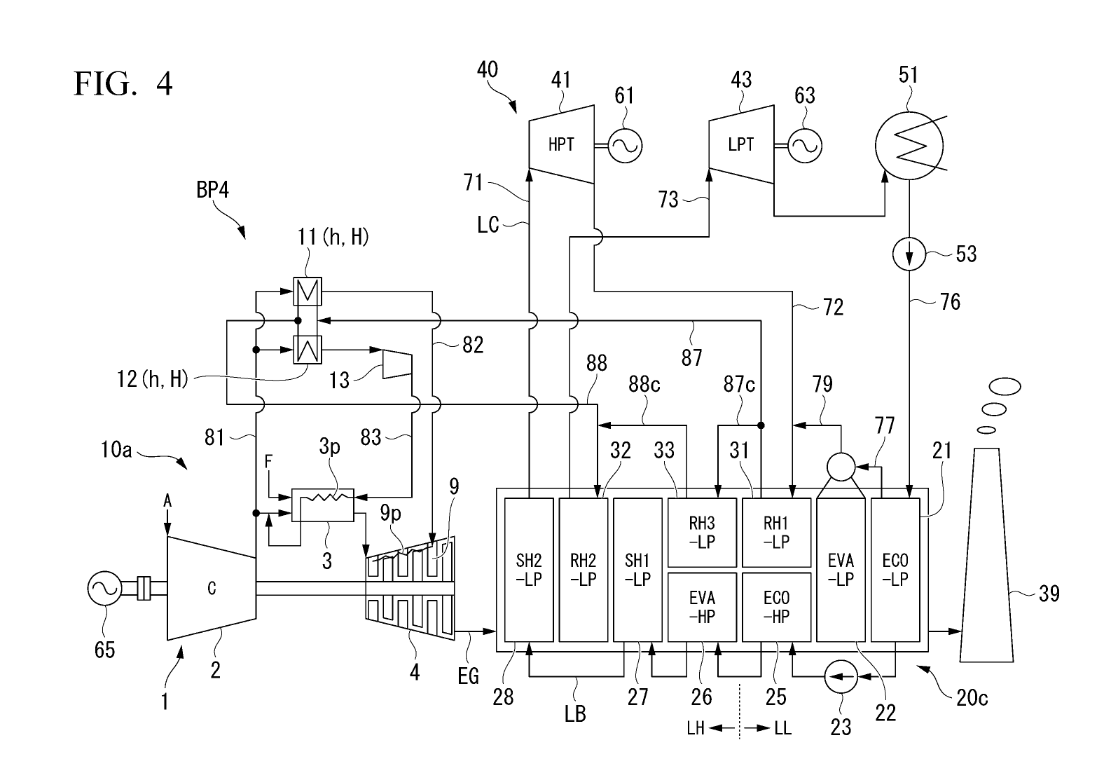

A fourth embodiment of the boiler plant according to the present invention will be described with reference to FIG. 4.

Similarly the above-described embodiments, a boiler plant BP4 of the present embodiment includes the gas turbine equipment 10, an exhaust heat recovery boiler 20c, the steam turbine equipment 40, and the stack 39. The gas turbine equipment 10 of the present embodiment is the same as the gas turbine equipment 10 of the first embodiment. The steam turbine equipment 40 of the present embodiment is the same as the steam turbine equipment 40 of the first embodiment. However, the exhaust heat recovery boiler 20c of the present embodiment is different from the exhaust heat recovery boiler 20 of the first embodiment.

Similarly to the exhaust heat recovery boiler 20 of the first embodiment, the exhaust heat recovery boiler 20c of the present embodiment includes the low pressure economizer (ECO-LP) 21, the low pressure evaporator (EVA-LP) 22, the high pressure pump 23, the high pressure economizer (ECO-HP) 25, the high pressure evaporator (EVA-HP) 26, the first high pressure superheater (SH1-HP) 27, the second high pressure superheater (SH2-HP) 28, the first reheater (RH1-LP) 31, and the second reheater (RH2-LP) 32. The exhaust heat recovery boiler 20c of the present embodiment further has a third reheater (RH3-LP) 33 which further heats the steam which is heated by the first reheater (RH1-LP) 31. In the flow direction of the exhaust gas EG, a position of the third reheater 33 and a position of the high pressure evaporator 26 are substantially the same as each other. Accordingly, the third reheater 33 constitutes a portion of the high temperature portion LH in the intra-boiler line LB.

Similarly to the first embodiment, also in the present embodiment, the steam outlet of the first reheater 31, the steam inlet of the first air cooler 11, and the steam inlet of the second air cooler 12 are connected to each other by the before-heating reheat steam line 87. The steam outlet of the first air cooler 11, the steam outlet of the second air cooler 12, and the steam inlet of the second reheater 32 are connected to each other by the after-heating reheat steam line 88. In the present embodiment, the steam outlet of the first reheater 31 and the steam inlet of the third reheater 33 are connected to each other by a third pre-reheating steam line 87c. The steam outlet of the third reheater 33 and the steam inlet of the second reheater 32 are connected to each other by a third after-reheating steam line 88c.

The steam exhausted from the high pressure steam turbine (first steam turbine) 41 is heated by the first reheater 31 (reheating step, downstream reheating step). Similarly to the first embodiment, a portion of the steam reheated by the first reheater 31 flows into the first air cooler 11 and the second air cooler 12 via the before-heating reheat steam line 87. The steam (first cooling medium) which has flowed into the first air cooler 11 (heater h) and the second air cooler 12 (heater h) is heat-exchanged with the air from the air compressor 2, and is heated to a temperature equal to or higher than the constant pressure specific heat maximum temperature Tmax in the high pressure evaporator 26 (heating step, boiler outside heating step). In addition, the steam heated by the first air cooler 11 (heater h) and the second air cooler 12 (heater h) flows into the second reheater 32 via the after-heating reheat steam line 88. The steam which has flowed into the second reheater 32 is further heated by the second reheater 32 (reheating step, upstream reheating step).

The rest of the steam heated by the first reheater 31 flows into the third reheater 33. The steam is heated to the temperature equal to or higher than the constant pressure specific heat maximum temperature Tmax in the high pressure evaporator 26 due to the exhaust gas EG, by the third reheater 33. The steam heated by the third reheater 33 flows into the second reheater 32 together with the steam heated by the first air cooler 11 and the second air cooler 12. That is, in the heating step of the present embodiment, the steam having the temperature lower than the constant pressure specific heat maximum temperature Tmax in the high pressure evaporator 26 is heated to the temperature equal to or higher than the constant pressure specific heat maximum temperature Tmax in cooperation with the heater h and the third reheater 33. As described above, the steam which has flowed into the second reheater 32 is further heated by the second reheater 32. Similarly to the first embodiment, this steam is supplied to the low pressure steam turbine (second steam turbine) 43 via the reheated steam supply line 73.

In a case where the heat quantity which heats the steam or water by the heater h is small, as in the present embodiment, a portion of the steam or water may be heated by the exhaust gas EG.

In the present embodiment, the steam or water which flows through the low temperature portion LL in the connection line LC and the intra-boiler line LB and has the temperature lower than the constant pressure specific heat maximum temperature Tmax is heated to be equal to or higher than the constant pressure specific heat maximum temperature Tmax by the first air cooler 11 (heater h) and the second air cooler 12 (heater h), and thereafter, is returned to the second reheater 32 positioned on the upstream side of the high pressure evaporator 26. For this reason, also in the present embodiment, the heat quantity of the temperature level near the constant pressure specific heat maximum temperature Tmax which can be consumed by the high pressure evaporator 26 out of the heat quantity of the exhaust gas EG increases. Accordingly, the flow rate of the steam generated by the high pressure evaporator 26 increases, and thus, it is possible to increase the output and efficiency of the steam turbine equipment 40. That is, also in the present embodiment, the heat of the temperature level near the constant pressure specific heat maximum temperature Tmax out of the heat of the exhaust gas EG can be effectively used by the high pressure evaporator 26.

### Fifth Embodiment of Boiler Plant

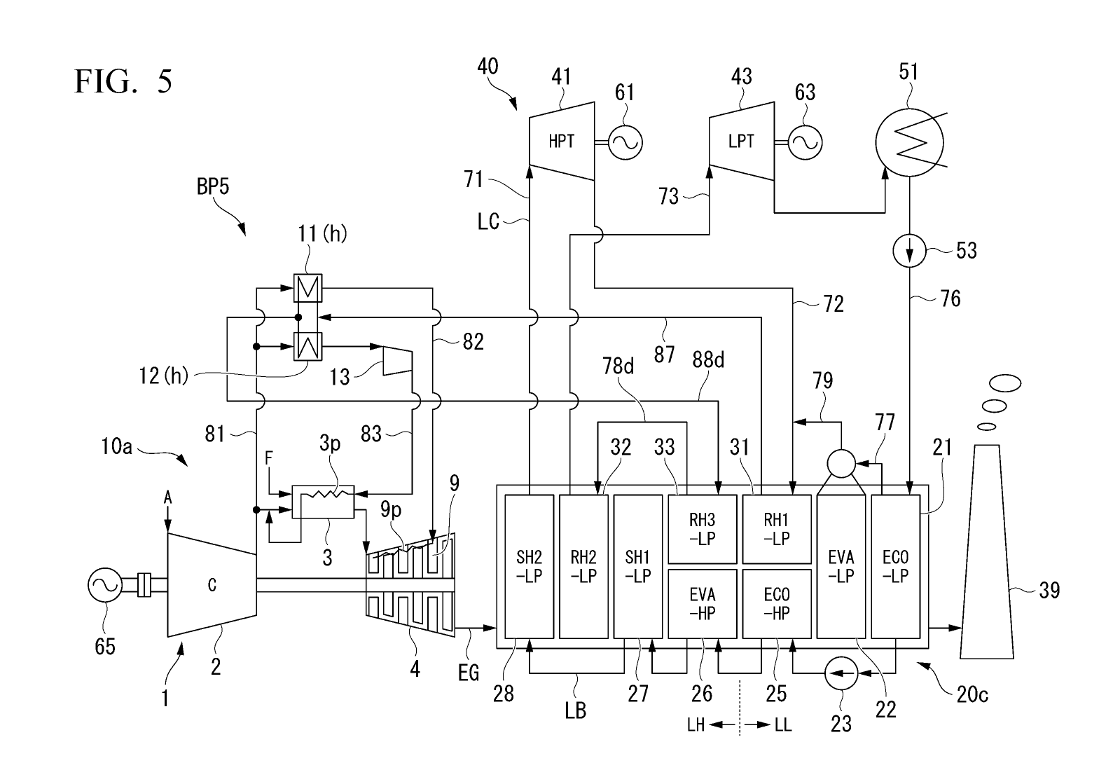

A fifth embodiment of the boiler plant according to the present invention will be described with reference to FIG. 5.

Similarly the above-described embodiments, a boiler plant BP5 of the present embodiment also includes the gas turbine equipment 10, the exhaust heat recovery boiler 20c, the steam turbine equipment 40, and the stack 39. The gas turbine equipment 10 of the present embodiment is the same as the gas turbine equipment 10 of the first embodiment. The steam turbine equipment 40 of the present embodiment is the same as the steam turbine equipment 40 of the first embodiment. The exhaust heat recovery boiler 20c of the present embodiment is the same as the exhaust heat recovery boiler 20c of the fourth embodiment. Similarly to the exhaust heat recovery boiler 20c of the fourth embodiment, the exhaust heat recovery boiler 20c of the present embodiment also includes the low pressure economizer 21, the low pressure evaporator 22, the high pressure pump 23, the high pressure economizer 25, the high pressure evaporator 26, the first high pressure superheater 27, the second high pressure superheater 28, the first reheater 31, the second reheater 32, and a third reheater 33. Similarly to the fourth embodiment, also in the present embodiment, the position of the third reheater 33 and the position of the high pressure evaporator 26 are substantially the same as each other in the flow direction of the exhaust gas EG.

Similarly to the first embodiment, also in the present embodiment, the steam outlet of the first reheater 31, the steam inlet of the first air cooler 11, and the steam inlet of the second air cooler 12 are connected to each other by the before-heating reheat steam line 87. Unlike the first embodiment and the fourth embodiment, in the present embodiment, the steam outlet of the first air cooler 11, the steam outlet of the second air cooler 12, and the steam inlet of the third reheater 33 are connected to each other by an after-heating reheat steam line 88d. The steam outlet of the third reheater 33 and the steam outlet of the second reheater 32 are connected to each other by a third after-reheating steam line 78d.

The steam exhausted from the high pressure steam turbine (first steam turbine) 41 is heated by the first reheater 31 (reheating step, downstream reheating step). Similarly to the first embodiment, the steam reheated by the first reheater 31 flows into the first air cooler 11 and the second air cooler 12 via the before-heating reheat steam line 87. The steam which has flowed into the first air cooler 11 (heater h) and the second air cooler 12 (heater h) is heat-exchanged with the air from the air compressor 2 so as to be heated (heating step, boiler outside heating step). In the first air cooler 11 (heater h) and the second air cooler 12 (heater h) of the present embodiment, if the steam is heated to the temperature equal to or higher than the constant pressure specific heat maximum temperature Tmax in the high pressure evaporator 26, it is possible to most effectively increase the flow rate of the steam generated in the high pressure evaporator 26, which is most preferable. However, in the case where the exhaust heat quantity in the first air cooler 11 (heater h) and the second air cooler 12 (heater h) is insufficient, in the first air cooler 11 (heater h) and the second air cooler 12 (heater h) of the present embodiment, it is not necessary to heat the steam to the temperature equal to or higher than the constant pressure specific heat maximum temperature Tmax in the high pressure evaporator 26. That is, the temperature of the steam heated by the first air cooler 11 (heater h) and the second air cooler 12 (heater h) of the present embodiment may be lower than the constant pressure specific heat maximum temperature Tmax in the high pressure evaporator 26. The steam heated by the first air cooler 11 and the second air cooler 12 flows into the third reheater 33 via the after-heating reheat steam line 88d. The steam which has flowed into the third reheater 33 is heated to the temperature equal to or higher than the constant pressure specific heat maximum temperature Tmax in the high pressure evaporator 26 due to the exhaust gas EG, by the third reheater 33 (upstream reheating step). As described above, in the heating step of the present embodiment, the steam having the temperature lower than the constant pressure specific heat maximum temperature Tmax in the high pressure evaporator 26 is heated to the temperature equal to or higher than the constant pressure specific heat maximum temperature Tmax in cooperation with the heater h and the third reheater 33. That is, in the present embodiment, the heating device H is constituted by the heater h and the third reheater 33.

The steam heated by the third reheater 33 flows into the second reheater 32. As described above, the steam which has flowed into the second reheater 32 is further heated by the second reheater 32. Similarly to the first embodiment, this steam is supplied to the low pressure steam turbine (second steam turbine) 43 via the reheated steam supply line 73.

In a case where the temperature of the heat source heating the steam or water by the heater h or the steam or water cannot be heated to the temperature equal to or higher than the constant pressure specific heat maximum temperature Tmax in the high pressure evaporator 26, as in the present embodiment, after the steam is heated by the heater h, the steam may be further heated by the reheater using the heat of the exhaust gas EG.

In the present embodiment, the steam or water which flows through the low temperature portion LL in the connection line LC and the intra-boiler line LB and has the temperature lower than the constant pressure specific heat maximum temperature Tmax is heated by the first air cooler 11 (heater h) and the second air cooler 12 (heater h) and is heated to be equal to or higher than the constant pressure specific heat maximum temperature Tmax by the third reheater 33, and thereafter, is returned to the second reheater 32 positioned on the upstream side of the high pressure evaporator 26. For this reason, also in the present embodiment, the heat quantity of the temperature level near the constant pressure specific heat maximum temperature Tmax which can be consumed by the high pressure evaporator 26 out of the heat quantity of the exhaust gas EG increases. Accordingly, the flow rate of the steam generated by the high pressure evaporator 26 increases, and thus, it is possible to increase the output and efficiency of the steam turbine equipment 40. That is, also in the present embodiment, the heat of the temperature level near the constant pressure specific heat maximum temperature Tmax out of the heat of the exhaust gas EG can be effectively used by the high pressure evaporator 26.

In addition, by using the heating using the exhaust heat in the air coolers 11 and 12 and the heating using the reheater 33 in combination and heating the steam or water to be equal to or higher than the constant pressure specific heat maximum temperature Tmax, even in a case where the exhaust heat quantity in the air coolers 11 and 12 is insufficient, it is possible to obtain the steam having the temperature equal to or higher than the constant pressure specific heat maximum temperature Tmax, to increase the flow rate of the steam generated in the high pressure evaporator 26, and to increase the output and efficiency of the steam turbine equipment 40.

### Sixth Embodiment of Boiler Plant

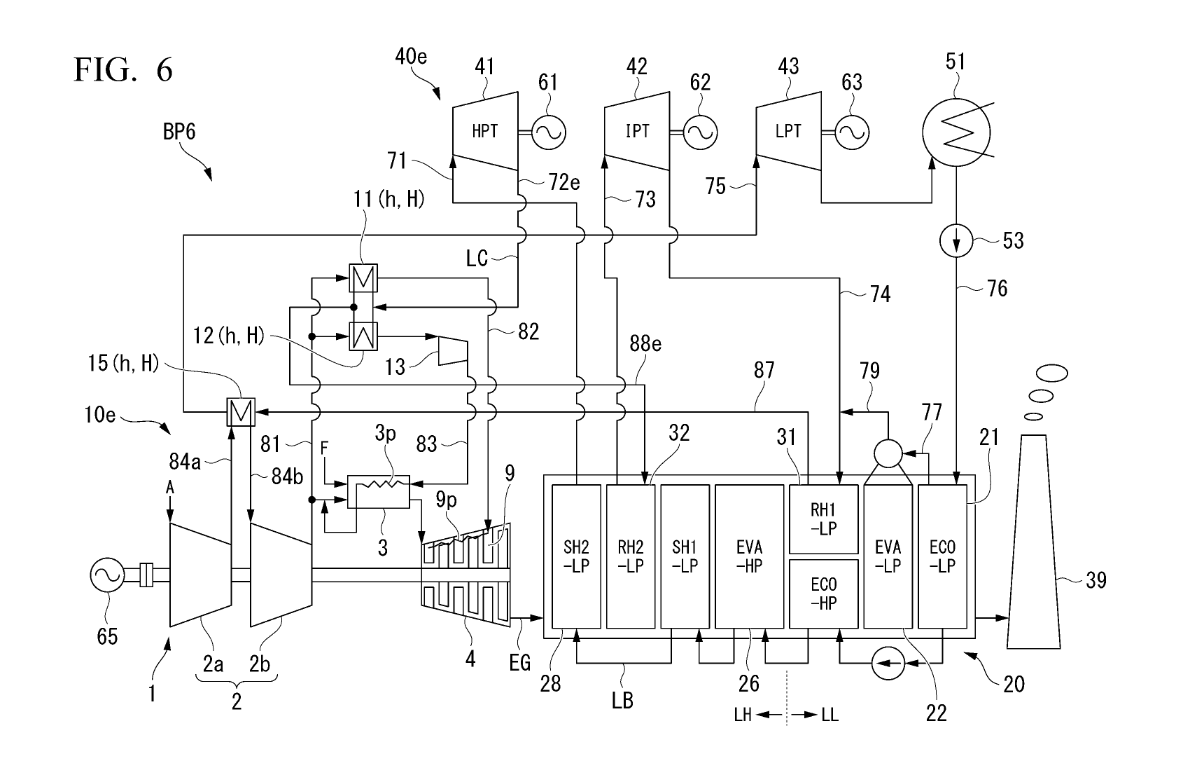

A sixth embodiment of the boiler plant according to the present embodiment will be described with reference to FIG. 6.

Similarly the above-described embodiments, a boiler plant BP6 of the present embodiment also includes a gas turbine equipment 10e, the exhaust heat recovery boiler 20, steam turbine equipment 40e, and the stack 39. The exhaust heat recovery boiler 20 of the present embodiment is the same as the exhaust heat recovery boiler 20 of the first embodiment. Meanwhile, the gas turbine equipment 10e of the present embodiment is different from the gas turbine equipment 10 of the first embodiment. In addition, the steam turbine equipment 40e of the present embodiment is different from the steam turbine equipment 40 of the first embodiment.

The gas turbine equipment 10e of the present embodiments includes the gas turbine 1, the first air cooler 11 and the second air cooler 12 which cool air, the boost compressor 13, and the intermediate cooler 15. The gas turbine 1 includes the air compressor 2, the combustor 3, and the turbine 4. Similarly the air compressor 2 of the second embodiment, the air compressor 2 of the present embodiment has the first compression unit 2a which compresses air and the second compression unit 2b which further compresses the air compressed by the first compression unit 2a.

The first air cooler 11 cools a portion of air discharged from the air compressor 2, and for example, feeds this air to the vane 9 which is one of the high temperature components. The second air cooler 12 cools a portion of the air discharged from the air compressor 2. The boost compressor 13 boosts the air cooled by the second air cooler 12, and for example, feeds this air to the combustor 3 which is one of the high temperature components. The air compressor 2, the air inlet of the first air cooler 11, and the air inlet of the second air cooler 12 are connected to each other by the compression air line 81. The air outlet of the first air cooler 11 and the air inlet in the cooling air passage (medium passage) 9p of the vane 9 are connected to each other by the first cooling air line 82. The air outlet of the second air cooler 12 and the air inlet in the cooling air passage (medium passage) 3p of the combustor 3 are connected to each other by a second cooling air line 83. The boost compressor 13 is provided in the second cooling air line 83.

The intermediate cooler 15 cools the air compressed by the first compression unit 2a and feeds the cooled air to the second compression unit 2b. The air discharge port of the first compression unit 2a and the air inlet of the intermediate cooler 15 are connected to each other by the first intermediate compression air line 84a. The air outlet of the intermediate cooler 15 and the air inlet of the second compression unit 2b are connected to each other by a second intermediate compression air line 84b. The air outlet of the second compression unit 2b is connected to the combustor 3 or the like.

The steam turbine equipment 40e of the present embodiment includes the high pressure steam turbine 41, an intermediate pressure steam turbine 42, and the low pressure steam turbine 43 which are driven by the steam generated by the exhaust heat recovery boiler 20, the condenser 51 which returns the steam exhausted from the low pressure steam turbine 43 to water, and the water supply pump 53 which returns the water in the condenser 51 to the exhaust heat recovery boiler 20. The rotors of the generators 61, 62, and 63 are connected to the turbine rotor of the high pressure steam turbine 41, a turbine rotor of the intermediate pressure steam turbine 42, and the turbine rotor of the low pressure steam turbine 43, respectively. The intermediate pressure steam turbine 42 is a steam turbine which is driven by the steam having a pressure lower than that of the steam which drives the high pressure steam turbine 41. In addition, the low pressure steam turbine 43 is a steam turbine which is driven by the steam having a pressure lower than that of the steam which drives the intermediate pressure steam turbine 42. The high pressure steam turbine 41, the intermediate pressure steam turbine 42, and the low pressure steam turbine 43 are the steam utilization devices which use the steam generated in the exhaust heat recovery boiler 20.

The steam outlet of the high pressure superheater 27 and the steam inlet of the high pressure steam turbine 41 are connected to each other by the high pressure steam supply line 71 through which the steam superheated by the high pressure superheater 27 is supplied to the high pressure steam turbine 41. In addition, the steam outlet of the high pressure steam turbine 41, the steam inlet of the first air cooler 11, and the steam inlet of the second air cooler 12 are connected to each other by a high pressure steam recovery line (before-heating line) 72e. The steam outlet of the first air cooler 11, the steam outlet of the second air cooler 12, and the steam inlet of the second reheated steam are connected to each other by an after-heating steam line (after-heating line) 88e. The steam outlet of the second reheater 32 and the steam inlet of the intermediate pressure steam turbine 42 are connected to each other by the reheated steam supply line 73. A steam outlet of the intermediate pressure steam turbine 42 and the steam inlet of the first reheater 31 are connected to each other by an intermediate pressure steam recovery line 74. The steam outlet of the first reheater 31 and the steam inlet of the intermediate cooler 15 are connected to each other by a before-heating reheat steam line (before-heating line) 87e. The steam outlet of the intermediate cooler 15 and the steam inlet of the low pressure steam turbine 43 are connected to each other by a low pressure steam supply line (after-heating line) 75. The steam outlet of the low pressure steam turbine 43 and the condenser 51 are connected to each other such that the steam exhausted from the low pressure steam turbine 43 is supplied to the condenser 51.

The steam which is superheated by the second high pressure superheater 28 is supplied to the high pressure steam turbine 41 via the high pressure steam supply line 71. The steam supplied to the high pressure steam turbine 41 rotates the turbine rotor of the high pressure steam turbine 41. The generator 61, which is connected to the high pressure steam turbine 41, generates electricity by the rotation of the turbine rotor. The high pressure steam which has passed through the high pressure steam turbine 41 flows into the first air cooler 11 and the second air cooler 12 via the high pressure steam recovery line (before-heating line) 72e. The steam which has flowed into the first air cooler 11 (heater h) and the second air cooler 12 (heater h) is heat-exchanged with the air from the air compressor 2, and is heated to the temperature equal to or higher than the constant pressure specific heat maximum temperature Tmax in the high pressure evaporator 26 (boiler outside heating step). The steam heated by the first air cooler 11 and the second air cooler 12 flows into the second reheater 32 via the after-heating steam line (after-heating line) 88e. The steam which has flowed into the second reheater 32 is further heated by the second reheater 32 (upstream reheating step). This steam is supplied to the intermediate pressure steam turbine 42 via the reheated steam supply line 73.

The steam supplied to the intermediate pressure steam turbine 42 rotates the turbine rotor of the intermediate pressure steam turbine 42. The generator 62, which is connected to the intermediate pressure steam turbine 42, generates electricity by the rotation of the turbine rotor. The steam, which has passed through the intermediate pressure steam turbine 42, is fed to the first reheater 31 via the intermediate pressure steam recovery line 74. In addition, the steam generated by the low pressure evaporator 22 is fed to the first reheater 31 via the low pressure steam line 79 and the intermediate pressure steam recovery line 74. That is, the steam which has passed through the intermediate pressure steam turbine 42 and the steam which is generated by the low pressure evaporator 22 are combined with each other and flow into the first reheater 31. This steam is heated to a temperature lower than the constant pressure specific heat maximum temperature Tmax in the high pressure evaporator 26, by the first reheater 31 (downstream reheating step).

The steam reheated by the first reheater 31 flows into the intermediate cooler 15 via the before-heating reheat steam line 87. The steam which has flowed into the intermediate cooler 15 (heater h) is heat-exchanged with the air from the first compression unit 2a of the air compressor 2, and is heated to the temperature equal to or higher than the constant pressure specific heat maximum temperature Tmax in the high pressure evaporator 26 (boiler outside heating step). The steam heated by the intermediate cooler 15 flows into the low pressure steam turbine 43 via the low pressure steam supply line (after-heating line) 75.

The steam which has flowed into the low pressure steam turbine 43 rotates the turbine rotor of the low pressure steam turbine 43. The generator 63, which is connected to the low pressure steam turbine 43, generates electricity by the rotation of the turbine rotor. The steam, which has passed through the low pressure steam turbine 43, flows into the condenser 51 and is returned to water by the condenser 51. The water in the condenser 51 is supplied to the low pressure economizer 21 by the water supply pump 53.

Also in the present embodiment, the steam or water which flows through the low temperature portion LL in the connection line LC and the intra-boiler line LB and has the temperature lower than the constant pressure specific heat maximum temperature Tmax is heated to be equal to or higher than the constant pressure specific heat maximum temperature Tmax by the heater h. Accordingly, also in the present embodiment, the flow rate of the steam generated by the high pressure evaporator 26 increases, and thus, it is possible to increase the output and efficiency of the steam turbine equipment 40e. That is, also in the present embodiment, the heat of the temperature level near the constant pressure specific heat maximum temperature Tmax out of the heat of the exhaust gas (heating fluid) EG can be effectively used by the high pressure evaporator 26.

As described above, in the present embodiment, the exhaust steam exhausted from the high pressure steam turbine (first steam turbine) 41 is heated by the first air cooler 11 (heater h) and the second air cooler 12 (heater h) (boiler outside heating step), and thereafter, the steam is fed to the intermediate pressure steam turbine (second steam turbine) 42. Moreover, in the present embodiment, the exhaust steam exhausted from the intermediate pressure steam turbine (first steam turbine) 42 is heated by the intermediate cooler 15 (heater h) (boiler outside heating step), and thereafter, this steam is fed to the low pressure steam turbine (second steam turbine) 43. In this way, two boiler outside heating steps may be performed in parallel in one boiler plant BP6.

In addition, in each of each embodiment described above, the steam exhausted from the steam turbine is heated by the reheater, and thereafter, is heated by the heater h. However, as in the present embodiment, the steam exhausted from the steam turbine (high pressure steam turbine 41) may be heated by the heater h (first air cooler 11 and the second air cooler 12) without passing through the reheater.

In addition, in the present embodiment, the exhaust steam exhausted from the high pressure steam turbine 41 is heated by the first air cooler 11 and the second air cooler 12. This exhaust steam may be heated by the intermediate cooler 15 or the high temperature component. In addition, in the present embodiment, the steam exhausted from the intermediate pressure steam turbine 42 is cooled by the intermediate cooler 15. However, the exhaust steam may be heated by the first air cooler 11, the second air cooler 12, or the high temperature component.

In addition, in the present embodiment, the two boiler outside heating steps are performed in parallel. However, only one of the two boiler outside heating steps may be performed.

### Seventh Embodiment of Boiler Plant

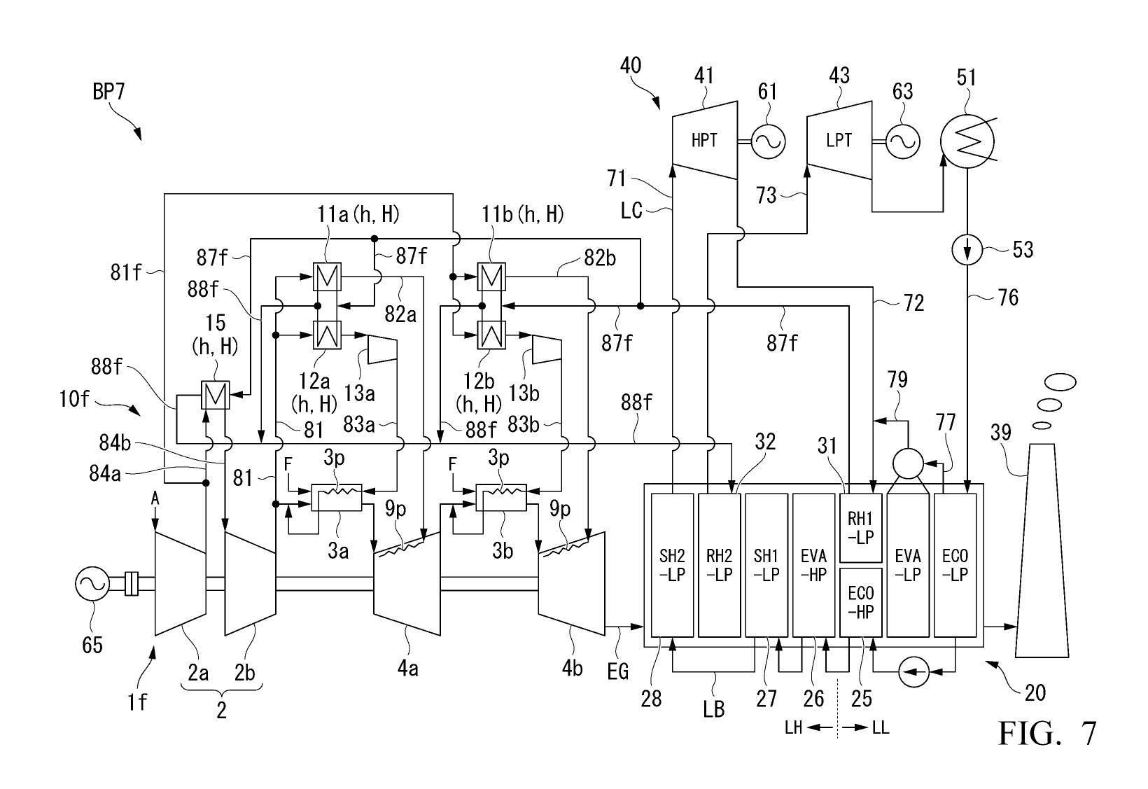

A seventh embodiment of the boiler plant according to the present invention will be described with reference to FIG. 7.

Similarly to the above-described embodiments, a boiler plant BP7 of the present embodiment also includes gas turbine equipment 10f, the exhaust heat recovery boiler 20, the steam turbine equipment 40, and the stack 39. The exhaust heat recovery boiler 20 of the present embodiment is the same as the exhaust heat recovery boiler 20 of the first embodiment. In addition, the steam turbine equipment 40 of the present embodiment is the same as the steam turbine equipment 40 of the first embodiment. Meanwhile, the gas turbine equipment 10f of the present embodiment is different from the gas turbine equipment 10 of the first embodiment.

The gas turbine equipment 10f of the present embodiment includes a gas turbine 1f, a first air cooler 11a, a second air cooler 12a, a third air cooler 11b, a fourth air cooler 12b, a first boost compressor 13a, a second boost compressor 13b, and the intermediate cooler 15. The gas turbine 1f includes the air compressor 2, a first combustor 3a, a second combustor 3b, a first turbine 4a, and a second turbine 4b. The first combustor 3a combusts the fuel F in the compressed air from the air compressor 2 to generate a first combustion gas. The first turbine 4a is driven by the first combustion gas. The second combustor 3b combusts the fuel F in the first combustion gas exhausted from the first turbine 4a to generate a second combustion gas. The second turbine 4b is driven by the second combustion gas. The second combustion gas exhausted from the second turbine 4b is fed to the exhaust heat recovery boiler 20 as the exhaust gas EG. Similarly to the air compressor 2 of the second embodiment, the air compressor 2 of the present embodiment the first compression unit 2a which compresses air and the second compression unit 2b which further compresses the air compressed by the first compression unit 2a. The intermediate cooler 15 cools the air compressed by the first compression unit 2a and feeds the cooled air to the second compression unit 2b.

The first air cooler 11a cools a portion of the air discharged from the air compressor 2 and feeds this air to the vane 9 of the first turbine 4a. The second air cooler 12a cools a portion of the air discharged from the air compressor 2. The first boost compressor 13a boosts the air cooled by the second air cooler 12a and feeds this air to the first combustor 3a. The third air cooler 11b cools a portion of the air discharged from the air compressor 2 and feeds this air to the vane of the second turbine 4b. The fourth air cooler 12b cools a portion of the air discharged from the air compressor 2. The second boost compressor 13b boosts the air cooled byh the fourth air cooler 12b and feeds this air to the second combustor 3b.

The air compressor 2, an air inlet of the first air cooler 11a, and an air inlet of the second air cooler 12a are connected to each other by the compression air line 81. An air outlet of the first air cooler 11a and an air inlet in the cooling air passage (medium passage) 9p of the vane of the first turbine 4a are connected to each other by a first cooling air line 82a. An air outlet of the second air cooler 12a and an air inlet in the cooling air passage (medium passage) 3p of the first combustor 3a are connected to each other by a second cooling air line 83a. The first boost compressor 13a is provided in the second cooling air line 83a. The air outlet of the first compression unit 2a and the air inlets of the third air cooler 11b and the fourth air cooler 12b are connected to each other by an intermediate compression air line 81f The air discharge port of the first compression unit 2a and the air inlet of the intermediate cooler 15 are connected to each other by the first intermediate compression air line 84a. The air outlet of the intermediate cooler 15 and the air inlet of the second compression unit 2b are connected to each other by the second intermediate compression air line 84b. An air outlet of the third air cooler 11b and the air inlet in the cooling air passage (medium passage) 9p of the vane of the second turbine 4b are connected to each other by a third cooling air line 82b. An air outlet of the fourth air cooler 12b and the air inlet in the cooling air passage (medium passage) 3p of the second combustor 3b are connected to each other by a fourth cooling air line 83b. The second boost compressor 13b is provided in the fourth cooling air line 83b.

The steam outlet of the high pressure superheater 27 and the steam inlet of the high pressure steam turbine 41 are connected to each other by the high pressure steam supply line 71. In addition, the steam outlet of the high pressure steam turbine 41 and the steam inlet of the first reheater 31 are connected to each other by a high pressure steam recovery line 72. The low pressure steam line 79 through which the steam generated by the low pressure evaporator 22 is fed to the first reheater 31 is connected to the high pressure steam recovery line 72. The steam outlet of the first reheater 31, the steam inlet of the first air cooler 11a, the steam inlet of the second air cooler 12a, the steam inlet of the third air cooler 11b, the steam inlet of the fourth air cooler 12b, and the steam inlet of the intermediate cooler 15 are connected to each other by a before-heating reheat steam line 87f The steam outlet of the first air cooler 11a, the steam outlet of the second air cooler 12a, the steam outlet of the third air cooler 11b, the steam outlet of the fourth air cooler 12b, the steam outlet of the intermediate cooler 15, and the steam inlet of the second reheater 32 are connected to each other by an after-heating reheat steam line 88f The steam outlet of the second reheater 32 and the steam inlet of the low pressure steam turbine 43 are connected to each other by the reheated steam supply line 73. The steam outlet of the low pressure steam turbine 43 and the condenser 51 are connected to each other such that the steam exhausted from the low pressure steam turbine 43 is supplied to the condenser 51.

In the present embodiment, the steam which has passed through the high pressure steam turbine (first steam turbine) 41 flows into the first reheater 31 via the high pressure steam recovery line 72. This steam, which has flowed into the first reheater 31, is heated to the temperature lower than the constant pressure specific heat maximum temperature Tmax in the high pressure evaporator 26, by the first reheater 31 (downstream reheating step). The steam reheated by the first reheater 31 flows into the intermediate cooler 15, the first air cooler 11a, the second air cooler 12a, the third air cooler 11b, and the fourth air cooler 12b via the before-heating reheat steam line 87f. The steam, which has flowed into the intermediate cooler 15 (heater h), is heat-exchanged with the air from the first compression unit 2a of the air compressor 2a, and is heated to the temperature equal to or higher than the constant pressure specific heat maximum temperature Tmax in the high pressure evaporator 26 (boiler outside heating step). The steam heated by the intermediate cooler 15 flows into the steam inlet of the second reheater 32 via the after-heating reheat steam line 88f. The steam, which has flowed into the first air cooler 11a, the second air cooler 12a, the third air cooler 11b, and the fourth air cooler 12b, is heated to the temperature equal to or higher than the constant pressure specific heat maximum temperature Tmax by in the high pressure evaporator 26 by the air cooler (heater h) (boiler outside heating step). The steam heated by the first air cooler 11a, the second air cooler 12a, the third air cooler 11b, and the fourth air cooler 12b flows into the steam inlet of the second reheater 32 via the after-heating reheat steam line 88f The steam which has flowed into the steam inlet of the second reheater 32 is further heated by the second reheater 32 (upstream reheating step). This steam is supplied to the low pressure steam turbine (second steam turbine) 43 via the reheated steam supply line 73.

Also in the present embodiment, the steam or water which flows through the low temperature portion LL in the connection line LC and the intra-boiler line LB and has the temperature lower than the constant pressure specific heat maximum temperature Tmax is heated to be equal to or higher than the constant pressure specific heat maximum temperature Tmax by the heater h. Accordingly, also in the present embodiment, the flow rate of the steam generated by the high pressure evaporator 26 increases, and thus, it is possible to increase the output and efficiency of the steam turbine equipment 40. That is, also in the present embodiment, the heat of the temperature level near the constant pressure specific heat maximum temperature Tmax out of the heat of the exhaust gas EG can be effectively used by the high pressure evaporator 26.

Moreover, in the present embodiment, by recovering the exhaust heat generated when the temperature of the cooling air of the gas turbine having the plurality of sets of combustors and turbines and the plurality of compression units is reduced, a large heat quantity can be used to increase the temperature of the steam or water, the flow rate of the steam generated by the high pressure evaporator 26 effectively increases, and thus, it is possible to increase the output and efficiency of the steam turbine equipment 40.

As described above, the gas turbine 1f of the present embodiment has two sets of the combustors and the turbines. In this way, the gas turbine may have two sets of the combustors and the turbines. In addition, the gas turbine may have three or more sets of the combustors and the turbines. In this way, in a case where the plurality of sets of combustors and turbines are provided, the air cooler (heater h) may be provided in each set. Moreover, the air compressor 2 of the present embodiment has two compression units. However, the air compressor 2 may have three or more compression units.

### Eighth Embodiment of Boiler Plant

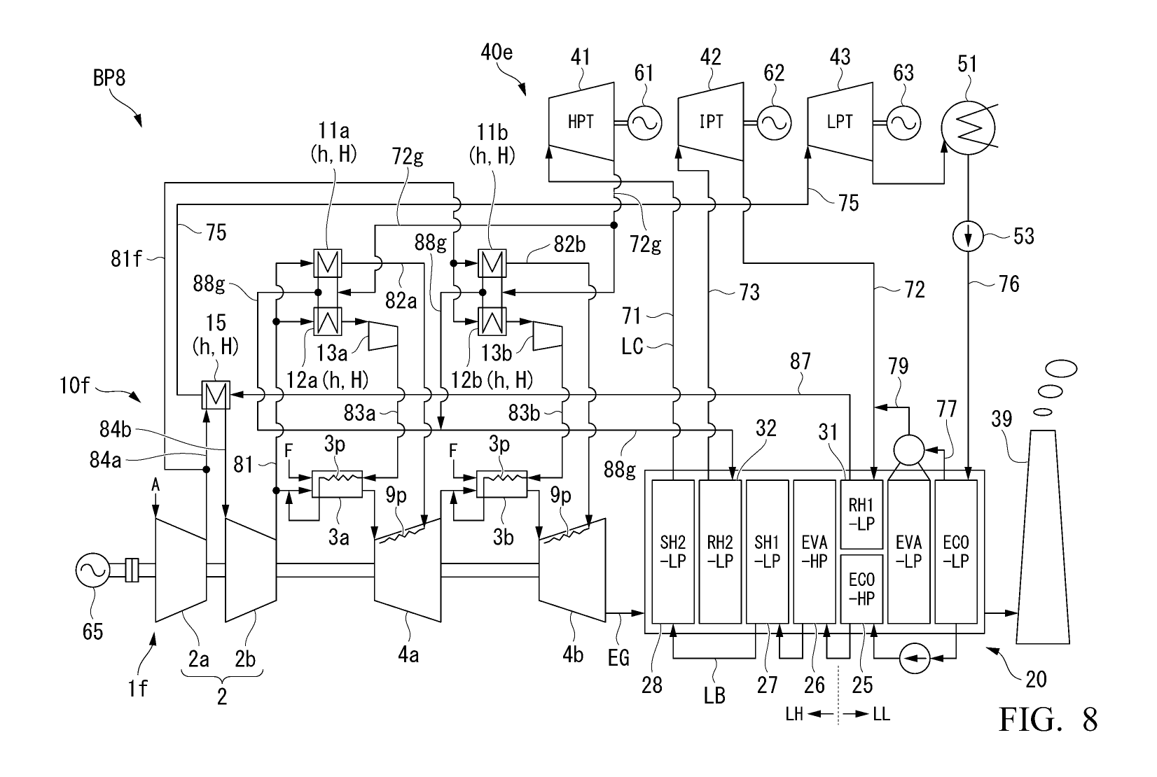

An eighth embodiment of the boiler plant according to the present invention will be described with reference to FIG. 8.

Similarly to the above-described embodiments, a boiler plant BP8 of the present embodiment also includes the gas turbine equipment 10f, the exhaust heat recovery boiler 20, steam turbine equipment 40e, and the stack 39. The exhaust heat recovery boiler 20 of the present embodiment is the same as the exhaust heat recovery boilers 20 of the first embodiment and the seventh embodiment. In addition, the steam turbine equipment 40e of the present embodiment is the same as the steam turbine equipment 40e of the sixth embodiment. Accordingly, the steam turbine equipment 40e of the present embodiment has the high pressure steam turbine 41, the intermediate pressure steam turbine 42, and the low pressure steam turbine 43. The gas turbine equipment 10f of the present embodiment is the same as the gas turbine equipment 10f of the seventh embodiment. Accordingly, the gas turbine equipment 10f of the present embodiment includes the gas turbine 1f, the first air cooler 11a, the second air cooler 12a, the third air cooler 11b, the fourth air cooler 12b, the first boost compressor 13a, the second boost compressor 13b, and the intermediate cooler 15. The gas turbine 1f includes the air compressor 2, the first combustor 3a, the second combustor 3b, the first turbine 4a, and the second turbine 4b. The air compressor 2 has the first compression unit 2a and the second compression unit 2b.

The steam outlet of the high pressure superheater 27 and the steam inlet of the high pressure steam turbine 41 are connected to each other by the high pressure steam supply line 71. The steam outlet of the high pressure steam turbine 41, the steam inlet of the first air cooler 11a, the steam inlet of the second air cooler 12a, the steam inlet of the third air cooler 11b, and the steam inlet of the fourth air cooler 12b are connected to each other by a high pressure steam recovery line (before-heating line) 72g. The steam outlet of the first air cooler 11a, the steam outlet of the second air cooler 12a, the steam outlet of the third air cooler 11b, the steam outlet of the fourth air cooler 12b, and the steam inlet of the second reheater 32 are connected to each other by an after-heating steam line (after-heating line) 88g. The steam outlet of the second reheater 32 and the steam inlet of the intermediate pressure steam turbine 42 are connected to each other by the reheated steam supply line 73. The steam outlet of the intermediate pressure steam turbine 42 and the steam inlet of the first reheater 31 are connected to each other by the intermediate pressure steam recovery line 74. The steam outlet of the first reheater 31 and the steam inlet of the intermediate cooler 15 are connected to each other by the before-heating reheat steam line (before-heating line) 87. The steam outlet of the intermediate cooler 15 and the steam inlet of the low pressure steam turbine 43 are connected to each other by the low pressure steam supply line (after-heating line) 75. The steam outlet of the low pressure steam turbine 43 and the condenser 51 are connected to each other such that the steam exhausted from the low pressure steam turbine 43 is supplied to the condenser 51.

The steam which is superheated by the second high pressure superheater 28 is supplied to the high pressure steam turbine 41 via the high pressure steam supply line 71. The steam supplied to the high pressure steam turbine 41 rotates the turbine rotor of the high pressure steam turbine 41. The generator 61, which is connected to the high pressure steam turbine 41, generates electricity by the rotation of the turbine rotor. The high pressure steam which has passed through the high pressure steam turbine 41 flows into the first air cooler 11a, the second air cooler 12a, the third air cooler 11b, and the fourth air cooler 12b via the high pressure steam recovery line (before-heating line) 72g. The steam which has flowed into the air cooler (heater h) is heat-exchanged with the air from the air compressor 2, and is heated to the temperature equal to or higher than the constant pressure specific heat maximum temperature Tmax in the high pressure evaporator 26 (boiler outside heating step). The steam heated by the air cooler flows into the second reheater 32 via the after-heating steam line (after-heating line) 88g. The steam which has flowed into the second reheater 32 is further heated by the second reheater 32 (upstream reheating step). This steam is supplied to the intermediate pressure steam turbine 42 via the reheated steam supply line 73.

The steam supplied to the intermediate pressure steam turbine 42 rotates the turbine rotor of the intermediate pressure steam turbine 42. The generator 62, which is connected to the intermediate pressure steam turbine 42, generates electricity by the rotation of the turbine rotor. The steam, which has passed through the intermediate pressure steam turbine 42, is fed to the first reheater 31 via the intermediate pressure steam recovery line 74. The steam which has flowed into the first reheater 31 is heated to the temperature lower than the constant pressure specific heat maximum temperature Tmax in the high pressure evaporator 26, by the first reheater 31 (downstream reheating step). The steam reheated by the first reheater 31 flows into the intermediate cooler 15 via the before-heating reheat steam line 87. The steam which has flowed into the intermediate cooler 15 (heater h) is heat-exchanged with the air from the first compression unit 2a of the air compressor 2, and is heated to the temperature equal to or higher than the constant pressure specific heat maximum temperature Tmax in the high pressure evaporator 26 (boiler outside heating step). The steam heated by the intermediate cooler 15 flows into the low pressure steam turbine 43 via the low pressure steam supply line (after-heating line) 75.

The steam which has flowed into the low pressure steam turbine 43 rotates the turbine rotor of the low pressure steam turbine 43. The generator 63, which is connected to the low pressure steam turbine 43, generates electricity by the rotation of the turbine rotor. The steam, which has passed through the low pressure steam turbine 43, flows into the condenser 51 and is returned to water by the condenser 51. The water in the condenser 51 is supplied to the low pressure economizer 21 by the water supply pump 53.

Also in the present embodiment, the steam or water which flows through the low temperature portion LL in the connection line LC and the intra-boiler line LB and has the temperature lower than the constant pressure specific heat maximum temperature Tmax is heated to be equal to or higher than the constant pressure specific heat maximum temperature Tmax by the heater h. Accordingly, also in the present embodiment, the flow rate of the steam generated by the high pressure evaporator 26 increases, and thus, it is possible to increase the output and efficiency of the steam turbine equipment 40. That is, also in the present embodiment, the heat of the temperature level near the constant pressure specific heat maximum temperature Tmax out of the heat of the exhaust gas EG can be effectively used by the high pressure evaporator 26.

As described above, in the present embodiment, the exhaust steam exhausted from the high pressure steam turbine (first steam turbine) 41 is heated by the first air cooler 11a (heater h), the second air cooler 12a (heater h), the third air cooler 11b (heater h), and the fourth air cooler 12b (heater h) (boiler outside heating step), and thereafter, the steam is fed to the intermediate pressure steam turbine (second steam turbine) 42. Moreover, in the present embodiment, the exhaust steam exhausted from the intermediate pressure steam turbine (first steam turbine) 42 is heated by the intermediate cooler 15 (heater h) (boiler outside heating step), and thereafter, this steam is fed to the low pressure steam turbine (second steam turbine) 43. In this way, two boiler outside heating steps may be performed in series in one boiler plant.

Moreover, in the present embodiment, the exhaust steam from the steam turbine (high pressure steam turbine 41) is heated by the heaters h (the first air cooler 11a, the second air cooler 12a, the third air cooler 11b, and the fourth air cooler 12b) without passing through the reheater (boiler outside heating step). In this way, the downstream reheating step is not performed on the exhaust steam from the steam turbine and the boiler outside heating step may be performed on the exhaust steam. In addition, in the present embodiment, the steam heated by the heater h (intermediate cooler 15) is supplied to the steam turbine (low pressure steam turbine 43) without passing through the reheater. In this way, after the boiler outside heating step is performed, the upstream reheating step may be performed.

Moreover, in the present embodiment, the exhaust steam exhausted from the high pressure steam turbine 41 is heated by the first air cooler 11a, the second air cooler 12a, the third air cooler 11b, and the fourth air cooler 12b. However, the exhaust steam may be heated by the intermediate cooler 15 or the high temperature component. In addition, in the present embodiment, the steam exhausted from the intermediate pressure steam turbine 42 is cooled by the intermediate cooler 15. However, the exhaust steam may be heated by the first air cooler 11a, the second air cooler 12a, the third air cooler 11b, the fourth air cooler 12b, or the high temperature component.

Moreover, in the present embodiment, the two boiler outside heating steps are performed in series. However, only one boiler outside heating step may be performed.

As described above, the gas turbine 1f of the present embodiment has two sets of the combustors and the turbines. In this way, the gas turbine may have two sets of the combustors and the turbines. In addition, the gas turbine may have three or more sets of the combustors and the turbines. In this way, in a case where the plurality of sets of combustors and turbines are provided, the air cooler (heater h) may be provided in each set. Moreover, the air compressor 2 of the present embodiment has two compression units. However, the air compressor 2 may have three or more compression units.

### Ninth Embodiment of Boiler Plant

A ninth embodiment of the boiler plant according to the present invention will be described with reference to FIG. 9.

Similarly the above-described embodiments, a boiler plant BP9 of the present embodiment includes the gas turbine equipment 10f, the exhaust heat recovery boiler 20, the steam turbine equipment 40, and the stack 39. The exhaust heat recovery boiler 20 of the present embodiment is the same as the exhaust heat recovery boilers 20 of the first embodiment and the seventh embodiment. In addition, the steam turbine equipment 40 of the present embodiment is the same as the steam turbine equipment 40 of the first embodiment and the seventh embodiment. Basically, the gas turbine equipment 10h of the present embodiment is the same as the gas turbine equipment 10f of the seventh embodiment. Accordingly, the gas turbine equipment 10h of the present embodiment includes the gas turbine 1f, the first air cooler 11a, the second air cooler 12a, the third air cooler 11b, the fourth air cooler 12b, the first boost compressor 13a, the second boost compressor 13b, and the intermediate cooler 15. The gas turbine 1f includes the air compressor 2, the first combustor 3a, the second combustor 3b, the first turbine 4a, and the second turbine 4b. The air compressor 2 includes the first compression unit 2a and the second compression unit 2b. The gas turbine equipment 10h of the present embodiment further includes a first fuel preheater 16 and a second fuel preheater 17 which heats the fuel F.

A first fuel line 89a through which the fuel F flows is connected to a fuel inlet of the first fuel preheater 16. A fuel outlet of the first fuel preheater 16 and a fuel inlet of the second fuel preheater 17 are connected to each other by a second fuel line 89b. A fuel outlet of the second fuel preheater 17, the fuel inlet of the first combustor 3a, and the fuel inlet of the second combustor 3b are connected to each other by a third fuel line 89c.

The steam outlet of the high pressure superheater 27 and the steam inlet of the high pressure steam turbine 41 are connected to each other by the high pressure steam supply line 71. In addition, the steam outlet of the high pressure steam turbine 41 and the steam inlet of the first reheater 31 are connected to each other by a high pressure steam recovery line 72. The low pressure steam line 79 through which the steam generated by the low pressure evaporator 22 is fed to the first reheater 31 is connected to the high pressure steam recovery line 72. The steam outlet of the first reheater 31, the steam inlet of the first air cooler 11a, the steam inlet of the second air cooler 12a, the steam inlet of the third air cooler 11b, the steam inlet of the fourth air cooler 12b, and the steam inlet of the intermediate cooler 15 are connected to each other by a before-heating reheat steam line 87f The steam outlet of the first air cooler 11a, the steam outlet of the second air cooler 12a, the steam outlet of the intermediate cooler 15, and the steam inlet of the second reheater 32 are connected to each other by a first after-heating reheat steam line 88ha. The steam outlet of the third air cooler 11b, the steam outlet of the fourth air cooler 12b, and the steam inlet of the second fuel preheater 17 are connected to each other by a second after-heating reheat steam line 88hb. The steam outlet of the second fuel preheater 17 and the steam inlet of the second reheater 32 are connected to each other by a third after-heating reheat steam line 88hc. The steam inlet of the first fuel preheater 16 and the high pressure evaporator 26 are connected to each other by a high pressure steam line 91. The steam outlet of the first fuel preheater 16 and the water supply line 76 are connected to each other by a return line 92. The steam outlet of the second reheater 32 and the steam inlet of the low pressure steam turbine 43 are connected to each other by the reheated steam supply line 73. The steam outlet of the low pressure steam turbine 43 and the condenser 51 are connected to each other such that the steam exhausted from the low pressure steam turbine 43 is supplied to the condenser 51.

In the present embodiment, a portion of the steam generated in the high pressure evaporator 26 flows into the first fuel preheater 16 via the high pressure steam line 91. In the first fuel preheater 16, this steam and the fuel F are heat-exchanged, and the steam is cooled and condensed so as to be water while the fuel F is heated. This water flows into the low pressure economizer 21 via the return line 92 and the water supply line 76. The fuel heated by the first fuel preheater 16 flows into the second fuel preheater 17.

Moreover, in the present embodiment, the high pressure steam which has passed through the high pressure steam turbine 41 flows into the first reheater 31 via the high pressure steam recovery line 72. The steam which has flowed into the first reheater 31 is heated to the temperature lower than the constant pressure specific heat maximum temperature Tmax in the high pressure evaporator 26, by the first reheater 31 (downstream reheating step). The steam reheated by the first reheater 31 flows into the intermediate cooler 15, the first air cooler 11a, the second air cooler 12a, the third air cooler 11b, and the fourth air cooler 12b via the before-heating reheat steam line 87f. The steam which has flowed into the intermediate cooler 15 (heater h) is heat-exchanged with the air from the first compression unit 2a of the air compressor 2, and is heated to the temperature equal to or higher than the constant pressure specific heat maximum temperature Tmax in the high pressure evaporator 26 (boiler outside heating step). The steam heated by the intermediate cooler 15 flows into the second reheater 32 via the first after-heating reheat steam line 88ha. The steam which has flowed into the first air cooler 11a, the second air cooler 12a, the third air cooler 11b, and the fourth air cooler 12b is heated to the temperature equal to or higher than the constant pressure specific heat maximum temperature Tmax in the high pressure evaporator 26 by the air coolers (heaters h). The steam heated by the first air cooler 11a and the second air cooler 12a flows into the second reheater 32 via the first after-heating reheat steam line 88ha. The steam heated by the third air cooler 11b and the fourth air cooler 12b flows into the second fuel preheater 17 via the second after-heating reheat steam line 88hb. In the second fuel preheater 17, the fuel heated by the first fuel preheater 16 is further heated by this steam (fuel preheating step). The steam which has passed through the second fuel preheater 17 flows into the second reheater 32 via the third after-heating reheat steam line 88hc. The steam which has flowed into the second reheater 32 is further heated by the second reheater 32 (upstream reheating step). The steam is supplied to the low pressure steam turbine 43 (second steam turbine) via the reheated steam supply line 73. In addition, the fuel heated by the second fuel preheater 17 is supplied to the first combustor 3a and the second combustor 3b via the third fuel line 89c.

Also in the present embodiment, the steam or water which flows through the low temperature portion LL in the connection line LC and the intra-boiler line LB and has the temperature lower than the constant pressure specific heat maximum temperature Tmax is heated to be equal to or higher than the constant pressure specific heat maximum temperature Tmax by the heater h. Accordingly, also in the present embodiment, the flow rate of the steam generated by the high pressure evaporator 26 increases, and thus, it is possible to increase the output and efficiency of the steam turbine equipment 40. That is, also in the present embodiment, the heat of the temperature level near the constant pressure specific heat maximum temperature Tmax out of the heat of the exhaust gas EG can be effectively used by the high pressure evaporator 26.

In addition, in the present embodiment, the fuel flowing into the combustors 3a and 3b is heated by the steam heated by the heater h. Accordingly, combustion efficiency of the fuel in the combustors 3a and 3b increases, and thus, it is possible to increase efficiency of the gas turbine 1f. Moreover, in the fuel preheaters 16 and 17 of the present embodiment, the fuel F is heated by the steam which does not contain oxygen substantially, and thus, ignition of the fuel F in the fuel preheaters 16 and 17 can be suppressed.

### Tenth Embodiment of Boiler Plant

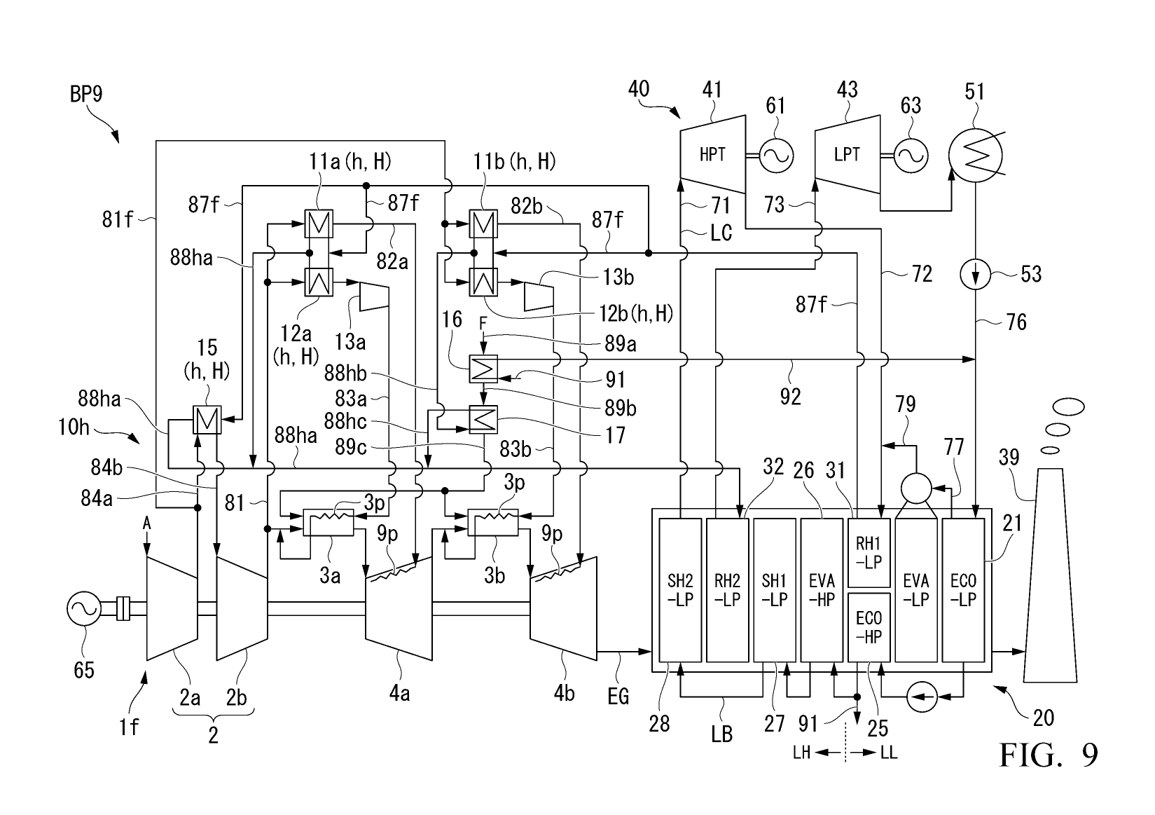

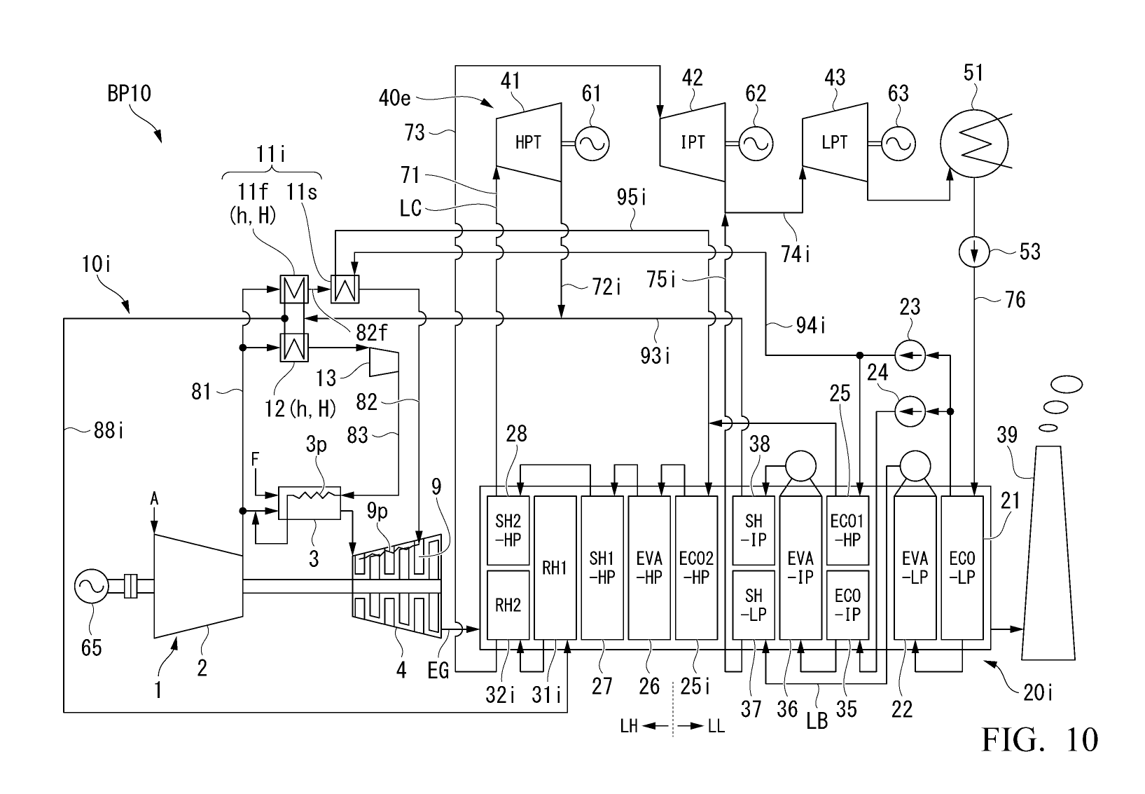

A tenth embodiment of the boiler plant according to the present invention will be described with reference to FIG. 10.

Similarly to the boiler plants of the above-described embodiments, as shown in FIG. 10, a boiler plant BP10 of the present embodiment also includes gas turbine equipment 10i, an exhaust heat recovery boiler 20i, the steam turbine equipment 40e, and the stack 39.

Similarly to the gas turbine equipment 10 of the first embodiment, the gas turbine equipment 10i includes the gas turbine 1, a first air cooler 11i and the second air cooler 12 which cools air, and the boost compressor 13. Similarly to the gas turbine 1 of the first embodiment, the gas turbine 1 includes the air compressor 2 which compresses the air A, a combustor 3 which combusts the fuel F in the air compressed by the air compressor 2 so as to generate a combustion gas, and the turbine 4 which is driven by a high temperature and high pressure combustion gas.

The first air cooler 11i has a primary air cooler 11f and a secondary air cooler 11s. The primary air cooler 11f cools a portion of the air discharged from the air compressor 2. Moreover, the secondary air cooler 11s further cools the air cooled by the primary air cooler 11f, and for example, feeds this air to the vane 9 which is one of the high temperature components. The second air cooler 12 cools a portion of the air discharged from the air compressor 2. The boost compressor 13 boosts the air cooled by the second air cooler 12, and for example, feeds this air to the combustor 3 which is one of the high temperature components. The air inlets of the air compressor 2 and the primary air coolers 11f are connected to each other by the compression air line 81. The air outlet of the primary air cooler 11f and the air inlet of the secondary air cooler 11s are connected to each other by a primary air cooling line 82f. The air outlet of the secondary air cooler his and the air inlet in the cooling air passage (medium passage) 9p of the vane 9 are connected to each other by the first cooling air line 82.

The steam turbine equipment 40e is the same as the steam turbine equipment 40e of the sixth embodiment. Accordingly, the steam turbine equipment 40e has the high pressure steam turbine 41, the intermediate pressure steam turbine 42, and the low pressure steam turbine 43.

The exhaust heat recovery boiler 20i generates steam using the heat of the exhaust gas EG (heating fluid) from the gas turbine 1. The exhaust heat recovery boiler 20i includes the low pressure economizer (ECO-LP) 21, the low pressure evaporator (EVA-LP) 22, an intermediate pressure pump 24, the high pressure pump 23, the first high pressure economizer (ECO-HP) 25, an intermediate pressure economizer (ECO-IP) 35, an intermediate pressure evaporator (EVA-IP) 36, an intermediate pressure superheater (SH1-IP) 38, a low pressure superheater (SH1-LP) 37, a second high pressure economizer 25i, the high pressure evaporator (EVA-HP) 26, the first high pressure superheater (SH1-HP) 27, a first reheater (RH1) 31i, the second high pressure superheater (SH2-HP) 28, and a second reheater (RH1) 32i. The low pressure economizer 21, the low pressure evaporator 22, the first high pressure economizer 25, the intermediate pressure economizer 35, the intermediate pressure evaporator 36, the intermediate pressure superheater 38, the low pressure superheater 37, the second high pressure economizer 25i, the high pressure evaporator 26, the first high pressure superheater 27, the first reheater 31i, the second high pressure superheater 28, and the second reheater 32i are disposed in this order from the upstream side toward the downstream side in the flow direction of the exhaust gas EG Moreover, in the present embodiment, a position of the first high pressure economizer 25 and a position of the intermediate pressure economizer 35 are substantially the same as each other in the flow direction of the exhaust gas EG Moreover, a position of the intermediate pressure superheater 38 and a position of the low pressure superheater 37 are substantially the same as each other in the flow direction of the exhaust gas EG. A position of the second high pressure superheater 28 and a position of the second reheater 32i are substantially the same as each other in the flow direction of the exhaust gas EG.

The low pressure economizer 21 heats the heat fed by the water supply pump 53 from the condenser 51. The intermediate pressure pump 24 and the high pressure pump 23 boosts a portion of the water heated by the low pressure economizer 21. A pressure of the water boosted by the high pressure pump 23 is higher than a pressure of the water boosted by the intermediate pressure pump 24. The low pressure evaporator 22 heats the rest of the water heated by the low pressure economizer 21 to generate steam. The low pressure superheater 37 superheats the steam from the low pressure evaporator 22.

The intermediate pressure economizer 35 heats the water boosted by the intermediate pressure pump 24. The intermediate pressure evaporator 36 further heats the water heated by the intermediate pressure economizer 35 to generate steam. The intermediate pressure superheater 38 superheats the steam from the intermediate pressure evaporator 36.

The first high pressure economizer 25 heats the high pressure water boosted by the high pressure pump 23. The second high pressure economizer 25i further heats the high pressure water heated by the first high pressure economizer 25. The high pressure evaporator 26 heats the high pressure water heated by the second high pressure economizer 25i to generate steam. The first high pressure superheater 27 superheats the steam from the high pressure evaporator 26. The second high pressure superheater 28 further superheats the steam superheated by the first high pressure superheater 27.

The first reheater 31i heats the exhaust steam exhausted from the high pressure steam turbine 41. The second reheater 32i further heats the steam heated by the first reheater 31i.

A steam outlet of the second high pressure superheater 28 and the steam inlet of the high pressure steam turbine 41 are connected to each other by the high pressure steam supply line 71. The steam outlet of the high pressure steam turbine 41, a steam inlet of the primary air cooler 11f, and the steam inlet of the second air cooler 12 are connected to each other by a high pressure steam recovery line 72i. A steam inlet of the intermediate pressure superheater 38, the steam inlet of the primary air cooler 11f, and the steam inlet of the second air cooler 12 are connected to each other by the intermediate pressure steam line 93i. That is, the steam exhausted from the high pressure steam turbine 41 and the steam superheated by the intermediate pressure superheater 38 flow into the primary air cooler 11f and the second air cooler 12. A steam outlet of the primary air cooler 11f, the steam outlet of the second air cooler 12, and the steam inlet of the first reheater 31i are connected to each other by an after-heating steam line 88i. A steam outlet of the second reheater 32i and the steam inlet of the intermediate pressure steam turbine 42 are connected to each other by the reheated steam supply line 73. The steam outlet of the intermediate pressure steam turbine 42 and the steam inlet of the low pressure steam turbine 43 are connected to each other by an intermediate pressure steam recovery line 74i. In addition, a steam outlet of the low pressure superheater 37 and the steam inlet of the low pressure steam turbine 43 are connected to each other by a low pressure steam supply line 75i. That is, the steam from the intermediate pressure steam turbine 42 and the steam from the low pressure superheater 37 are supplied to the low pressure steam turbine 43. The steam outlet of the low pressure steam turbine 43 and the condenser 51 are connected to each other such that the steam exhausted from the low pressure steam turbine 43 is supplied to the condenser 51.

A discharge port of the high pressure pump 23 and a high pressure water inlet of the secondary air cooler 11s are connected to each other by a high pressure water line 94i. A high pressure water outlet of the secondary air cooler 11s and a high pressure water line of the high pressure evaporator 26 are connected to each other by a heating high pressure water line 95i.

The high pressure steam supply line 71, the high pressure steam recovery line 72i, the after-heating steam line 88i, the reheated steam supply line 73, and the low pressure steam supply line 75i constitute the connection line LC which connects the steam turbine and the exhaust heat recovery boiler 20i to each other. The device such as the low pressure economizer 21 included in the exhaust heat recovery boiler 20i and the lines which connect a plurality of devices included in the exhaust heat recovery boiler 20i to each other constitute the intra-boiler line LB. The high pressure steam recovery line 72i, the after-heating steam line 88i, and the low pressure steam supply line 75i in the connection line LC are low temperature portions LL through which the steam having the temperature lower than the constant pressure specific heat maximum temperature Tmax in the high pressure evaporator 26 flows. Moreover, in the intra-boiler line LB, a line on the downstream side of the high pressure evaporator 26 in the flow of the exhaust gas EG is the low temperature portion LL through which the steam or water having the temperature lower than the constant pressure specific heat maximum temperature Tmax flows.

Each of the primary air cooler 11f and the second air cooler 12 is a heat exchanger which performs heat exchange between the air and steam discharged from the air compressor 2 and heats the steam while cooling the air. Accordingly, each of the primary air cooler 11f and the second air cooler 12 is also the heater h which heats the steam.

A portion of the air discharged from the air compressor 2 flows into the primary air cooler 11f and the second air cooler 12 via the compression air line 81. Moreover, the steam from the intermediate pressure superheater 38 and the steam exhausted from the high pressure steam turbine 41 flow into the primary air cooler 11f and the second air cooler 12. A temperature of this steam is lower than the constant pressure specific heat maximum temperature Tmax in the high pressure evaporator 26. In the primary air cooler 11f and the second air cooler 12, the air and the steam are heat-exchanged, and thus, the steam is heated to be equal to or higher than the constant pressure specific heat maximum temperature Tmax in the high pressure evaporator 26 while the air is cooled (boiler outside heating step). The steam heated by the primary air cooler 11f and the second air cooler 12 flows into the first reheater 31i via the after-heating steam line 88i. The steam which has flowed into the first reheater 31i is heated by the first reheater 31i (upstream heating step). The steam heated by the first reheater 31i is further heated by the second reheater 32i, and thereafter, is supplied to the intermediate pressure steam turbine 42. The air cooled by the second air cooler 12 is boosted by the boost compressor 13, and thereafter, is supplied into the cooling air passage (medium passage) 3p of the combustor 3 via the second cooling air line 83 to cool the combustor 3. The air cooled by the primary air cooler 11f flows into the secondary air cooler 11s. Moreover, the high pressure water from the first high pressure economizer 25 flows into the secondary air cooler 11s. In the secondary air cooler 11s, the air and the high pressure water are heat-exchanged, and thus, the air is further cooled and the high pressure water is heated. The air cooled by the secondary air cooler 11s is supplied into the cooling air passage (medium passage) 9p of the vane 9 and thus, the vane 9 is cooled. The heated high pressure water which has passed through the secondary air cooler 11s flows into the second high pressure economizer 25i. As described above, the high pressure water heated by the first high pressure economizer 25 also flows into this second high pressure economizer 25i. As described above, the high pressure water which has flowed into the second high pressure economizer 25 is heated by the second high pressure economizer 25i, and thereafter, flows into the high pressure evaporator 26.

In the present embodiment, the steam or water which flows through the low temperature portion LL in the connection line LC and the intra-boiler line LB and has the temperature lower than the constant pressure specific heat maximum temperature Tmax is heated to be equal to or higher than the constant pressure specific heat maximum temperature Tmax by the first air cooler 11 (heater h) and the second air cooler 12 (heater h) (boiler outside heating step), and thereafter, is returned to the first reheater 31i positioned on the upstream side of the high pressure evaporator 26. For this reason, the heat quantity of the temperature level near the constant pressure specific heat maximum temperature Tmax which can be consumed by the high pressure evaporator 26 out of the heat quantity of the exhaust gas EG increases. Accordingly, the flow rate of the steam generated by the high pressure evaporator 26 increases, and thus, it is possible to increase the output and efficiency of the steam turbine equipment 40e. That is, in the present embodiment, the heat of the temperature level near the constant pressure specific heat maximum temperature Tmax out of the heat of the exhaust gas EG can be effectively used by the high pressure evaporator 26.

Moreover, also in the present embodiment, the steam or water flowing through the low temperature portion LL is set to a heat source which is heated by the first air cooler 11 (heater h) and the second air cooler 12 (heater h), the exhaust heat (excluding the exhaust gas EG) of the gas turbine equipment 10 is used, and thus, it is possible to reduce energy cost for obtaining the heat source.

### Eleventh Embodiment of Boiler Plant

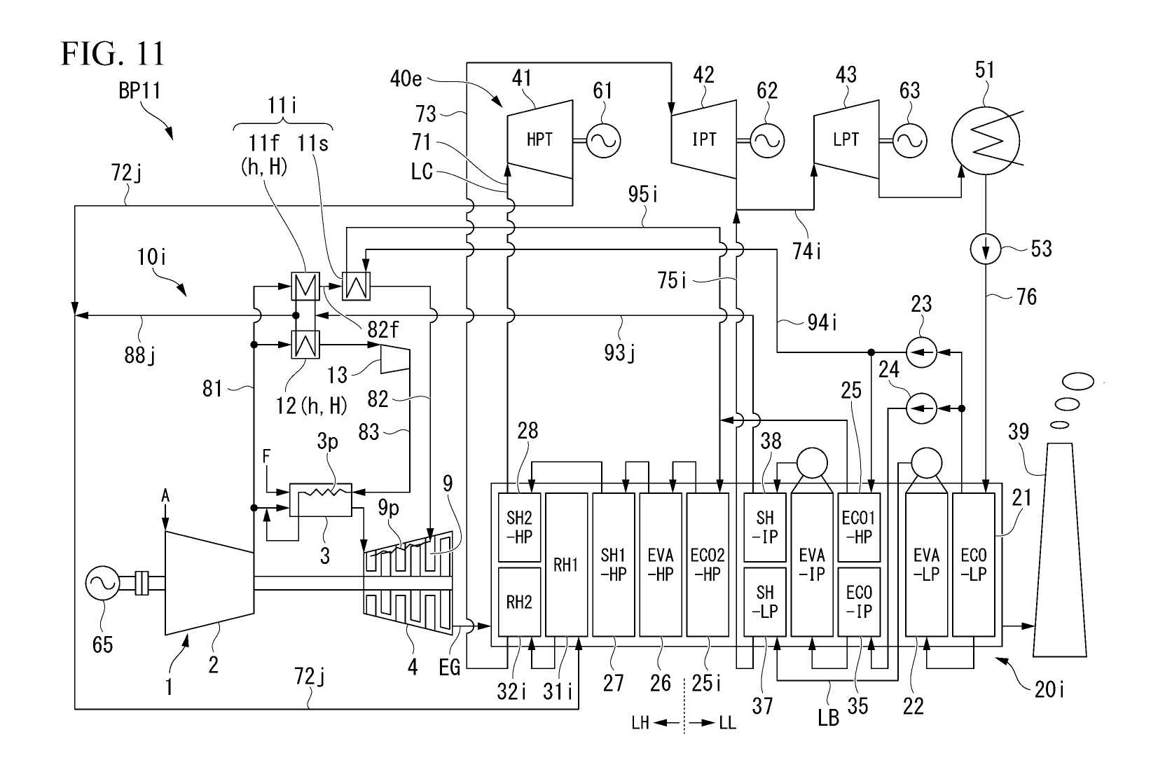

An eleventh embodiment of the boiler plant according to the present invention will be described with reference to FIG. 11.

Similarly to the boiler plants of the above-described embodiments, as shown in FIG. 11, a boiler plant BP11 of the present embodiment also includes the gas turbine equipment 10i, the exhaust heat recovery boiler 20i, the steam turbine equipment 40e, and the stack 39. The gas turbine equipment 10i is the same as the gas turbine equipment 10i of the tenth embodiment. The exhaust heat recovery boiler 20i of the present embodiment is also the same as the exhaust heat recovery boiler 20i of the tenth embodiment. The steam turbine equipment 40e is also the same as the steam turbine equipment 40e of the tenth embodiment. However, in the boiler plant BP11 of the present embodiment, a line which connects a plurality of facilities to each other is different from that of the boiler plant BP10 of the tenth embodiment.

Similarly to the tenth embodiment, the steam outlet of the second high pressure superheater 28 and the steam inlet of the high pressure steam turbine 41 are connected to each other by the high pressure steam supply line 71. Unlike the tenth embodiment, the steam outlet of the high pressure steam turbine 41 is connected to the steam inlet of the first reheater 31i by a high pressure steam recovery line 72j. The steam inlet of the primary air cooler 11f and the steam inlet of the second air cooler 12 are connected to only the steam outlet of the intermediate pressure superheater 38 by an intermediate pressure steam line 93j. That is, the steam exhausted from the steam turbine does not flow into the primary air cooler 11f and the second air cooler 12 and only the steam before being supplied to the steam turbine flows into the primary air cooler 11f and the second air cooler 12. The steam outlet of the primary air cooler 11f, the steam outlet of the second air cooler 12, and the steam inlet of the first reheater 31i are connected to each other by the after-heating steam line 88j. That is, the steam exhausted from the high pressure steam turbine 41 and the steam which has flowed out from the primary air cooler 11f and the second air cooler 12 flow into the first reheater 31i. Similarly to the tenth embodiment, the steam outlet of the second reheater 32i and the steam inlet of the intermediate pressure steam turbine 42 are connected to each other by the reheated steam supply line 73. Similarly the tenth embodiment, the steam outlet of the intermediate pressure steam turbine 42 and the steam inlet of the low pressure steam turbine 43 are connected to each other by an intermediate pressure steam recovery line 74i. In addition, similarly to the tenth embodiment, the steam outlet of the low pressure superheater 37 and the steam inlet of the low pressure steam turbine 43 are connected to each other by a low pressure steam supply line 75i.

The discharge port of the high pressure pump 23 and the high pressure water inlet of the secondary air cooler 11s are connected to each other by the high pressure water line 94i. The high pressure water outlet of the secondary air cooler 11s and the high pressure water line of the high pressure evaporator 26 are connected to each other by the heating high pressure water line 95i.

The high pressure steam supply line 71, the high pressure steam recovery line 72j, the reheated steam supply line 73, and the low pressure steam supply line 75i constitute the connection line LC which connects the steam turbine and the exhaust heat recovery boiler 20i to each other. The device such as the low pressure economizer 21 included in the exhaust heat recovery boiler 20i and the lines which connect a plurality of devices included in the exhaust heat recovery boiler 20i to each other constitute the intra-boiler line LB. The high pressure steam recovery line 72j, and the low pressure steam supply line 75i in the connection line LC are low temperature portions LL through which the exhaust steam having the temperature lower than the constant pressure specific heat maximum temperature Tmax in the high pressure evaporator 26 flows. Moreover, in the intra-boiler line LB, the line on the downstream side of the high pressure evaporator 26 in the flow of the exhaust gas EG is the low temperature portion LL through which the steam or water having the temperature lower than the constant pressure specific heat maximum temperature Tmax flows.

Each of the primary air cooler 11f and the second air cooler 12 is a heat exchanger which performs heat exchange between the air and steam discharged from the air compressor 2 and heats the steam while cooling the air. Accordingly, each of the primary air cooler 11f and the second air cooler 12 is also the heater h which heats the steam.

Similarly to the tenth embodiment, a portion of the air discharged from the air compressor 2 flows into the primary air cooler 11f and the second air cooler 12 via the compression air line 81. Moreover, only the steam from the intermediate pressure superheater 38 flow into the primary air cooler 11f and the second air cooler 12. A temperature of this steam is lower than the constant pressure specific heat maximum temperature Tmax in the high pressure evaporator 26. In the primary air cooler 11f and the second air cooler 12, the air and the steam are heat-exchanged, and thus, the steam is heated to be equal to or higher than the constant pressure specific heat maximum temperature Tmax in the high pressure evaporator 26 while the air is cooled (boiler outside heating step). The steam heated by the primary air cooler 11f and the second air cooler 12 flows into the first reheater 31i via the after-heating steam line 88j. The steam which has flowed into the first reheater 31i is heated by the first reheater 31i (upstream heating step). The steam heated by the first reheater 31i is further heated by the second reheater 32i, and thereafter, is supplied to the intermediate pressure steam turbine 42. The air cooled by the second air cooler 12 is boosted by the boost compressor 13, and thereafter, is supplied into the cooling air passage (medium passage) 3p of the combustor 3 via the second cooling air line 83 to cool the combustor 3. The air cooled by the primary air cooler 11f flows into the secondary air cooler 11s. In addition, the high pressure water from the first high pressure economizer 25 flows into the secondary air cooler 11s. In the secondary air cooler 11s, the air and the high pressure water are heat-exchanged, and thus, the air is further cooled, and the high pressure water is heated. The air cooled by the secondary air cooler 11s is supplied into the cooling air passage (medium passage) 9p of the vane 9, and thus, the vane 9 is cooled. The heated high pressure water which has passed through the secondary air cooler 11s flows into the second high pressure economizer 25i. As described above, the high pressure water heated by the first high pressure economizer 25 also flows into the second high pressure economizer 25i. As describe above, the high pressure water which has flowed into the second high pressure economizer 25 is heated by the second high pressure economizer 25i, and thereafter, flows into the high pressure evaporator 26.

Similarly to the tenth embodiment, also in the present embodiment, the steam or water which flows through the low temperature portion LL in the connection line LC and the intra-boiler line LB and has the temperature lower than the constant pressure specific heat maximum temperature Tmax is heated to be equal to or higher than the constant pressure specific heat maximum temperature Tmax by the first air cooler 11 (heater h) and the second air cooler 12 (heater h), and thereafter, is returned to the first reheater 31i positioned on the upstream side of the high pressure evaporator 26. Accordingly, the flow rate of the steam generated by the high pressure evaporator 26 increases, and thus, it is possible to increase the output and efficiency of the steam turbine equipment 40. That is, in the present embodiment, the heat of the temperature level near the constant pressure specific heat maximum temperature Tmax out of the heat of the exhaust gas EG can be effectively used by the high pressure evaporator 26.

The heater of each embodiment described above heats the steam exhausted from the steam turbine. Meanwhile, the heater of the present embodiment heats only the steam before being supplied to the steam turbine. That is, the heater may heat only the steam exhausted from the steam turbine, may heat only the steam before being supplied to the steam turbine, or may heat the steam exhausted from the steam turbine and the steam before being supplied to the steam turbine.

### Twelfth Embodiment of Boiler Plant

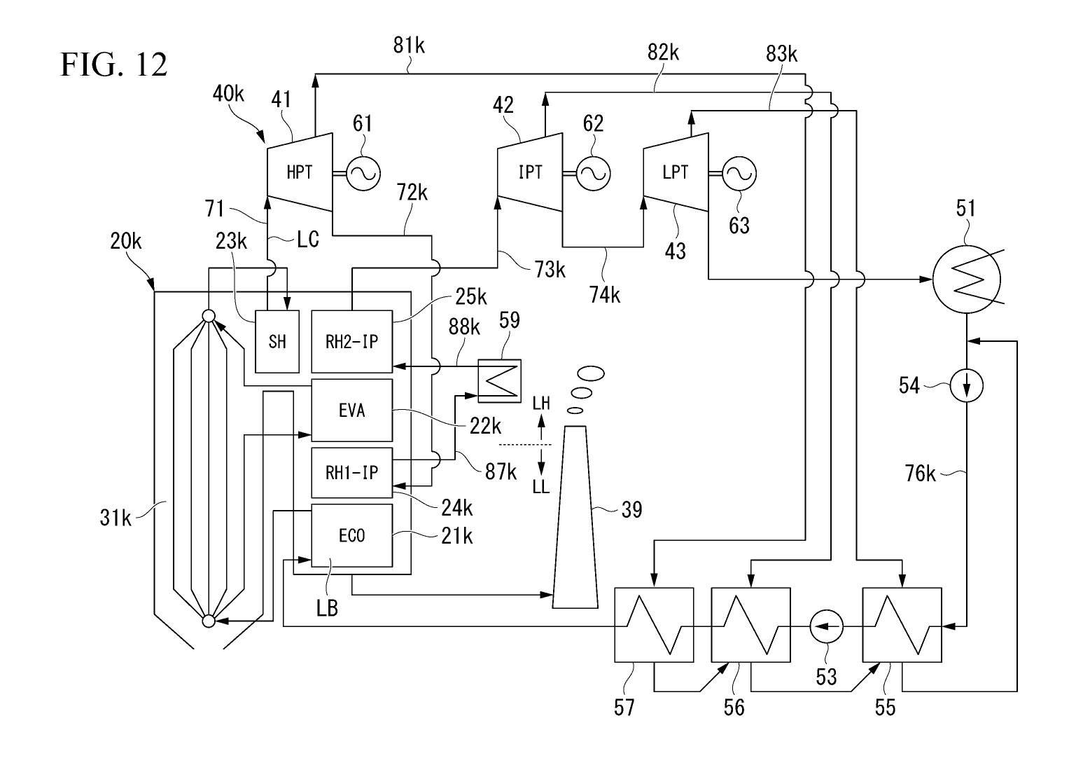

A twelfth embodiment of the boiler plant according to the present invention will be described with reference to FIG. 12.

As shown in FIG. 12, a boiler plant BP12 of the present embodiment includes a boiler 20k, steam turbine equipment 40k, and a plant outside heater 59 which heats steam using heat in other plants.

The steam turbine equipment 40k includes the high pressure steam turbine 41, the intermediate pressure steam turbine 42, the low pressure steam turbine 43, the condenser 51 which returns steam exhausted from the low pressure steam turbine 43 to water, a condensate pump 54 which boosts the water from the condenser 51, the water supply pump 53 which further boosts the water boosted by the condensate pump 54 and feeds the water to the boiler 20k, and water supply heaters 55, 56, and 57 which heat the water from the condenser 51. The rotors of the generators 61, 62, and 63 are connected to the turbine rotor of the high pressure steam turbine 41, the turbine rotor of the intermediate pressure steam turbine 42, and the turbine rotor of the low pressure steam turbine 43, respectively. The water supply heaters 55, 56, and 57 include the primary water supply heater 55 which primarily heats the water from the condenser 51, the secondary water supply heater 56 which further heats the water heated by the primary water supply heater 55, and the tertiary water supply heater 57 which further heats the water heated by the secondary water supply heater 56. The water supply pump 53 is disposed between the primary water supply heater 55 and the secondary water supply heater 56, boosts the water heated by the primary water supply heater 55, and feeds this water to the boiler 20k via the secondary water supply heater 56 and the tertiary water supply heater 57.

The boiler in the boiler plant of each of the above-described embodiments is an exhaust heat recovery boiler which generates steam using the heat of the exhaust gas EG from the gas turbine without a furnace. Meanwhile, the boiler 20k in the boiler plant BP12 of the present embodiment is a boiler having a furnace 31k. The combustion gas generated by the furnace 31k flows into the boiler 20k. The boiler 20k heats water or the like using this combustion gas to generate steam. The combustion gas exhausted from the boiler 20k is discharged to the atmosphere via the stack 39.

The boiler 20k of the present embodiment has the furnace 31k which combusts a fuel such as oil and a gas, an economizer 21k which heats water, an evaporator 22k which generate steam from the water heated by the economizer 21k, a superheater 23k which superheats the heat generated by the evaporator 22k to generate a high pressure steam, and a first reheater 24k and a second reheater 25k which heat the steam exhausted from the high pressure steam turbine 41.

Here, in the flow direction of the combustion gas flowing through the boiler 20k, a side on which the stack 39 exists with respect to the furnace 31k is referred to as a downstream side, and a side opposite to the downstream side is referred to as an upstream side. The economizer 21k, the first reheater 24k, the evaporator 22k, the second reheater 25k, the superheater 23k, and the furnace 31k are disposed in this order from the downstream side toward the upstream side of the boiler 20k.

A steam outlet of the superheater 23k and the steam inlet of the high pressure steam turbine 41 are connected to each other by the high pressure steam supply line 71. The steam outlet of the high pressure steam turbine 41 and a steam inlet of the first reheater 24k are connected to each other by a high pressure steam recovery line 72k. A steam outlet of the first reheater 24k and a steam inlet of the plant outside heater 59 are connected to each other by a pre-heating steam line 87k. A steam outlet of the plant outside heater 59 and a steam inlet of the second reheater 25k are connected to each other by an after-heating steam line 88k. A steam outlet of the second reheater 25k and the steam inlet of the intermediate pressure steam turbine 42 are connected to each other by a reheated steam supply line 73k. The steam outlet of the intermediate pressure steam turbine 42 and the steam inlet of the low pressure steam turbine 43 are connected to each other by an intermediate pressure steam recovery line 74k. The steam outlet of the low pressure steam turbine 43 and the condenser 51 are connected to each other such that the steam exhausted from the low pressure steam turbine 43 is supplied to the condenser 51.

The condenser 51 and the economizer 21k are connected to each other by a water supply line 76k. The condensate pump 54, the primary water supply heater 55, the water supply pump 53, the secondary water supply heater 56, and the tertiary water supply heater 57 are disposed in this order from the upstream side toward the downstream side in a flow of the water. A steam extraction port of the low pressure steam turbine 43 and the primary water supply heater 55 are connected to each other by a low pressure extraction line 83k through which the steam extracted from the steam extraction port is fed to the primary water supply heater 55 as a heat source in the primary water supply heater 55. A steam extraction port of the intermediate pressure steam turbine 42 and the secondary water supply heater 56 are connected to each other by an intermediate pressure extraction line 82k through which the steam extracted from the steam extraction port is fed to the secondary water supply heater 56 as a heat source in the secondary water supply heater 56. A steam extraction port of the high pressure steam turbine 41 and the tertiary water supply heater 57 are connected to each other by a high pressure extraction line 81k through which the steam extracted from the steam extraction port is fed to the tertiary water supply heater 57 as a heat source in the tertiary water supply heater 57.

The high pressure steam supply line 71, the high pressure steam recovery line 72k and the reheated steam supply line 73k constitute the connection line LC which connects the steam turbine and the boiler 20k to each other. The device such as the economizer 21k included in the boiler 20k and the lines which connect a plurality of devices included in the boiler 20k to each other constitute the intra-boiler line LB. The high pressure steam recovery line 72k in the connection line LC are the low temperature portion LL through which the steam having the temperature lower than the constant pressure specific heat maximum temperature Tmax in the evaporator 22k flows. Moreover, in the intra-boiler line LB, a line on the downstream side of the evaporator 22k in the flow of the exhaust gas is the low temperature portion LL through which the steam or water having a temperature lower than the constant pressure specific heat maximum temperature Tmax flows.

Next, an operation of the boiler plant BP12 of the present embodiment will be described.

Water heated by the plurality of water supply heaters 55, 56, and 57 is supplied to the economizer 21k on the most downstream side of the boiler 20k. The economizer 21k performs heat exchange between this water and the combustion gas so as to heat the water. The water heated by the economizer 21k is fed to the evaporator 22k via a water pipe provided in the furnace 31k or the like. This water is further heated by the evaporator 22k, and thus, becomes steam. This steam is fed to the superheater 23k via the water pipe provided in the furnace 38k or the like. This steam is further superheated by the superheater 23k. This steam is supplied to the high pressure steam turbine 41 via the high pressure steam supply line 71.

The steam which has passed through the high pressure steam turbine 41 is fed to the first reheater 24k via the high pressure steam recovery line 72k. In the first reheater 24k, this steam is heated to the temperature lower than the constant pressure specific heat maximum temperature Tmax in the evaporator 22k. In the plant outside heater 59, the steam is heated to the temperature equal to or higher than the constant pressure specific heat maximum temperature Tmax in the evaporator 22k. In the second reheater 25k, this steam is further heated and is supplied to the intermediate pressure steam turbine 42. The steam which has passed through the intermediate pressure steam turbine 42 is supplied to the low pressure steam turbine 43. The steam which passed through the low pressure steam turbine 43 is returned to water by the condenser 51, and this water is fed from the condenser 51 to the economizer 21k via the water supply line 76k.

Also in the present embodiment, the steam or water which flows through the low temperature portion LL in the connection line LC and the intra-boiler line LB and has the temperature lower than the constant pressure specific heat maximum temperature Tmax is heated to be equal to or higher than the constant pressure specific heat maximum temperature Tmax by the plant outside heater 59, and thereafter, is returned to the second reheater 25k on the upstream side of the evaporator 22k. For this reason, the heat quantity of the temperature level near the constant pressure specific heat maximum temperature Tmax which can be consumed by the evaporator 22k out of the heat quantity of the combustion gas increases. Accordingly, the flow rate of the steam generated by evaporator 22k increases, and thus, it is possible to increase the output and efficiency of the steam turbine equipment 40k. That is, also in the present embodiment, the heat of the temperature level near the constant pressure specific heat maximum temperature Tmax out of the heat of the combustion gas can be effectively used by the evaporator 22k.

That is, as in the present embodiment, even if there is no gas turbine equipment, for example, if the steam or water can be heated using the heat in other plants, it is possible to effectively use the heat of the combustion gas in the boiler. In addition, even in a case where there is only one evaporator as in the present embodiment, it is possible to effectively use the heat of the combustion gas in the boiler.

### Modification Example of Heater

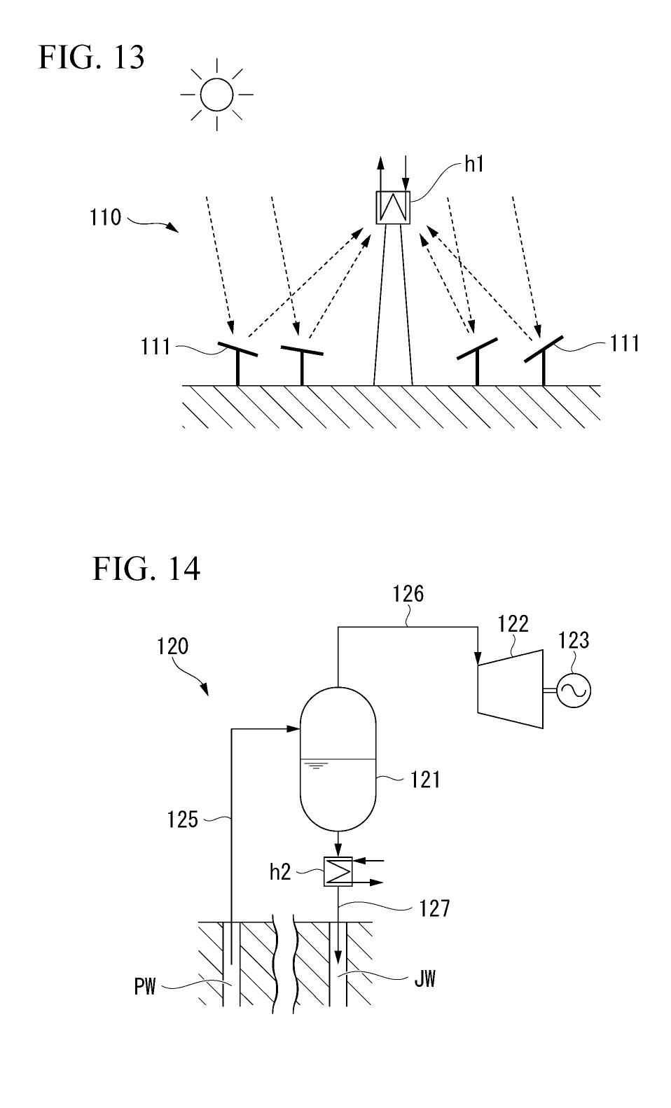

Various modification examples of the heater will be described with reference to FIGS. 13 to 17. In addition, each heater described below is a plant outside heater which heats the steam or water using the heat in other plants. These heaters can be used not only as the heater of the twelfth embodiment but also as the heaters of the first to eleventh embodiments.

As shown in FIG. 13, a heater h1 of a first modification example uses heat in a solar energy plant 110. This solar energy plant 110 includes heliostats 111 which apply sunlight to a heater h1 through which steam or water passes. The steam or water in the heater h1 is heated by the sunlight from the heliostats 111.

As shown in FIG. 14, a heater h2 of a second modification example uses heat in a geothermal power generation plant 120. The geothermal power generation plant 120 includes a moisture separator 121, a steam turbine 122, and a generator 123. The moisture separator 121 is connected to a steam pumping line 125 through which steam is pumped from a production well PW. The moisture separator 121 separates moisture from the pumped steam. A steam outlet of the moisture separator 121 and a steam inlet of the steam turbine 122 are connected to each other by a steam supply line 126. A drain discharge line 127 is connected to the drain outlet of the moisture separator 121. The high temperature water, which is a drain in the moisture separator 121, is returned to a production well JW through the drain discharge line 127. The heater h2 is provided in the drain discharge line 127. The steam or water in the heater h2 is heated by the high temperature water passing through the drain discharge line 127. In addition, for example, the heater h2 may be provided in the steam pumping line 125.

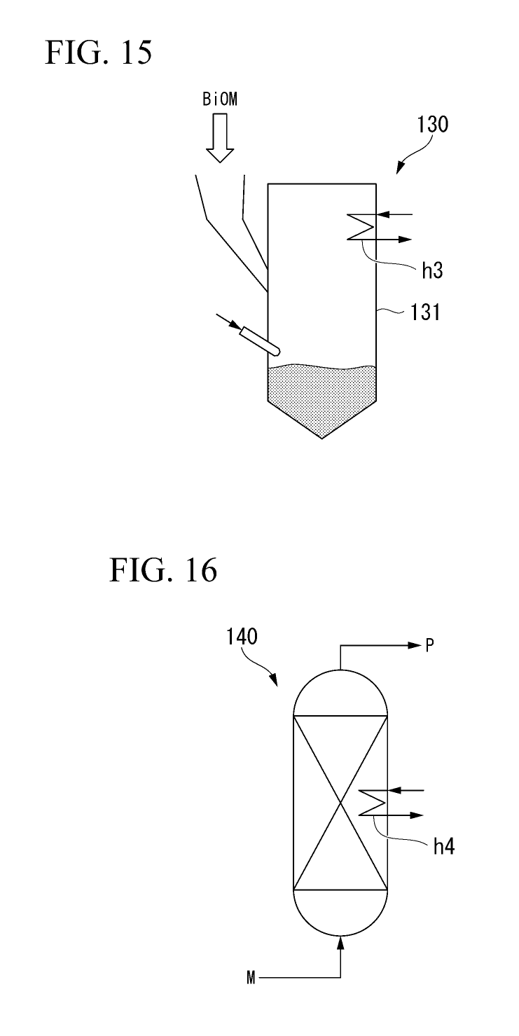

As shown in FIG. 15, a heater h3 of a third modification example uses heat in a biomass plant 130. The biomass plant 130 includes a boiler 131 which has biomass BiOM as a fuel. For example, examples of the biomass BiO include a wood fuel such as sawdust, bioethanol obtained from sugar cane or the like, biogas generated from garbage and manure of livestock, or the like. The heater h3 is disposed in the boiler 131. The steam or water in the heater h3 is heated by the combustion gas in the boiler 131.

As shown in FIG. 16, a heater h4 of a fourth modification example uses heat in a chemical plant 140. This chemical plant 140 has a reactor 141. The heater h4 is disposed in the reactor 141. Steam or water in the heater h4 is heated by heat generated in a process of converting a material M input to the reactor 141 into a product P.

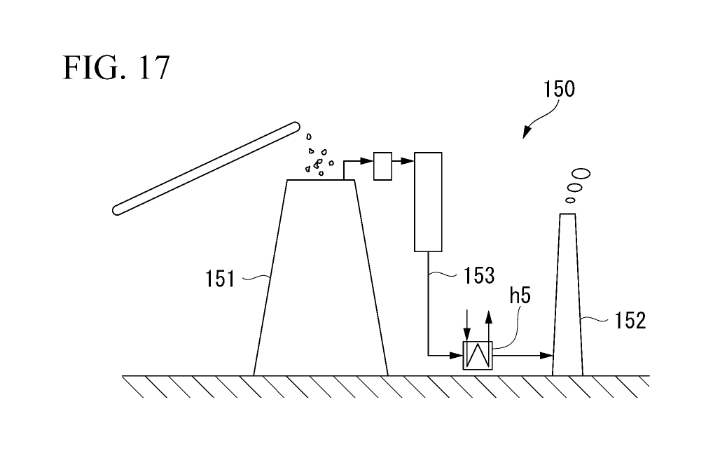

As shown in FIG. 17, a heater h5 of a fifth modification example uses heat in a blast furnace plant 150 of a steel mill. The blast furnace plant 150 has a blast furnace 151, a stack 152 which exhausts a blast furnace gas generated in the blast furnace 151, and a blast furnace gas line 153 which connects the blast furnace 151 and the stack 152 to each other. The heater h5 is provided in the blast furnace gas line 153. Steam or water in the heater h5 is heated by the blast furnace gas.

### Other Modification Examples

A target to be driven by the steam turbine or the gas turbine in each of the above-described embodiments and modification examples is the generator. However, the target to be driven by the steam turbine or the gas turbine may not be the generator, and for example, may be a rotary machine such as a pump.

### BRIEF DESCRIPTION OF THE REFERENCE SYMBOLS

1, 1f: gas turbine
2: air compressor
2a: first compression unit
2b: second compression unit
3: combustor
3p: cooling air passage (medium passage)
3pb: steam passage (medium passage)
3a: first combustor
3b: second combustor
4: turbine
4a: first turbine
4b: second turbine
5: turbine rotor
6: rotor shaft
7: blade
8: turbine casing
9: vane
9p: cooling air passage (medium passage)
9pb: steam passage (medium passage)
10, 10a, 10b, 10e, 10f, 10i: gas turbine equipment
11, 11a, 11i: first air cooler
11b: third air cooler
11f: primary air cooler
11s: secondary air cooler
12, 12a: second air cooler
12b: fourth air cooler
13: boost compressor
13a: first boost compressor
13b: second boost compressor
15: intermediate cooler
16: first fuel preheater
17: second fuel preheater
20, 20c, 20i: exhaust heat recovery boiler (boiler)
20k: boiler
21: low pressure economizer
21k: economizer
22: low pressure evaporator
22k: evaporator
23: high pressure pump
23k: superheater
24: intermediate pressure pump
24k: first reheater
25: high pressure economizer (or first high pressure economizer)
25i: second high pressure economizer
25k: second reheater
26: high pressure evaporator
27: first high pressure superheater
28: second high pressure superheater
31, 31i: first reheater
31k: furnace
32, 32i: second reheater
33: third reheater
35: intermediate pressure economizer
36: intermediate pressure evaporator
37: low pressure superheater
38: intermediate pressure superheater
39: stack
40, 40e, 40k: steam turbine equipment
41: high pressure steam turbine (steam utilization device)
42: intermediate pressure steam turbine (steam utilization device)
43: low pressure steam turbine (steam utilization device)
51: condenser
53: water supply pump
54: condensate pump
55: primary water supply heater
56: secondary water supply heater
57: secondary water supply heater
59: plant outside heater
61, 62, 63, 65: generator
71: high pressure steam supply line
72, 72e, 72g, 72j, 72k: high pressure steam recovery line
73, 73k: reheated steam supply line
74, 74i, 74k: intermediate pressure steam recovery line
75, 75i: low pressure steam supply line
76, 76k: water supply line
77: first low pressure water line
78: second low pressure water line
78d: third after-reheating steam line
79: low pressure steam line
81: compression air line
81f: intermediate compression air line
81k: high pressure extraction line
82, 82a: first cooling air line
82b: third cooling air line
82f: primary air cooling line
82k: intermediate pressure extraction line
83, 83a: second cooling air line
83b: fourth cooling air line
83k: low pressure extraction line
84a: first intermediate compression air line
84b: second intermediate compression air line
87, 87a, 87b: before-heating reheat steam line (before-heating line)
87c: third pre-reheating steam line
87k: pre-heating steam line
88, 88a, 88b: after-heating reheat steam line (after-heating line)
88c: third after-reheating steam line
88e, 88g, 88i, 88j, 88k: after-heating steam line
88ha: first after-heating reheat steam line
88hb: second after-heating reheat steam line
88hc: third after-heating reheat steam line
89a: first fuel line
89b: second fuel line
89c: third fuel line
91: high pressure steam line
92: return line
93i, 93j: intermediate pressure steam line
94i: high pressure water line
95i: heating high pressure water line
110: solar energy plant
120: geothermal power generation plant
130: biomass plant
140: chemical plant
150: blast furnace plant
BP1, BP2, BP3, BP4, BP5, BP6, BP7, BP8, BP9, BP10, BP11, BP12: boiler plant
EG: exhaust gas (heating fluid)
H: heating device
h, h1, h2, h3, h4, h5: heater
LC: connection line
LB: intra-boiler line
LL: low temperature portion

1. A boiler plant comprising:
a boiler which is configured to heat water by a heating fluid to generate steam;
a steam utilization device which is configured to use the steam from the boiler;
a connection line which connects the boiler and the steam utilization device to each other;
a heating device which is configured to heat steam using at least energy excluding thermal energy of the heating fluid;
a before-heating line through which steam is fed to the heating device; and
an after-heating line through which the steam heated by the heating device is fed to a steam acceptance destination,
wherein the boiler has an intra-boiler line through which water or steam flows and one or more evaporators which heat water to generate steam,
wherein a first evaporator having a highest internal pressure, from among the one or more evaporators, is configured to heat water having a temperature lower than a constant pressure specific heat maximum temperature, at which constant pressure specific heat in a pressure in the first evaporator is maximum, to be equal to or higher than the constant pressure specific heat maximum temperature,
wherein the before-heating line is connected to a low temperature portion, from among the steam utilization device, the connection line, and the intra-boiler line, through which steam having a temperature lower than the constant pressure specific heat maximum temperature flows such that the steam in the low temperature portion is fed to the heating device, and
wherein the heating device has ability to heat the steam in the low temperature portion to be equal to or higher than the constant pressure specific heat maximum temperature.

2. The boiler plant according to claim 1,
wherein the heating device has a heater which is configured to heat steam using only the energy excluding the thermal energy of the heating fluid.

3. The boiler plant according to claim 1,
wherein the steam utilization device has a steam turbine.

4. The boiler plant according to claim 3,
wherein exhaust steam exhausted from the steam turbine via the before-heating line flows into the heating device and the heating device heats the exhaust steam exhausted from the steam turbine.

5. The boiler plant according to claim 3,
wherein the steam utilization device has a first steam turbine and a second steam turbine which is driven by steam having a pressure lower than that of the first steam turbine, as the steam turbine, and
wherein exhaust steam exhausted from the first steam turbine via the before-heating line flows into the heating device, and the heating device is configured to heat the exhaust steam and feed the heated exhaust steam to the second steam turbine via the after-heating line.

6. The boiler plant according to claim 4,
wherein the boiler has a reheater which is configured to perform heat exchange between the exhaust steam exhausted from the steam turbine and the heating fluid to heat the exhaust steam,
wherein the heating device has a heater which is configured to heat steam using only energy excluding the thermal energy of the heating fluid, and
wherein the heater is configured to heat the exhaust steam which flows out from the reheater or the exhaust steam which flows into the reheater.

7. The boiler plant according to claim 6,
wherein the reheater has a downstream reheater which is disposed on a downstream side in a flow direction of the heating fluid, with respect to the first evaporator, and
wherein the heater is configured to heat the exhaust steam which is heated by the downstream reheater.

8. The boiler plant according to claim 6,
wherein the reheater has an upstream reheater which is disposed at the same position as that of the first evaporator in a flow direction of the heating fluid or is disposed on an upstream side in the flow direction of the heating fluid with respect to the first evaporator, and
wherein the upstream reheater is configured to heat the exhaust steam heated by the heater.

9. The boiler plant according to claim 8,
wherein the heating device has the heater and the upstream reheater.

10. The boiler plant according to claim 2,
wherein the heater has a plant outside heat exchanger which is configured to heat steam using heat in other plants.

11. The boiler plant according to claim 2, further comprising:
a gas turbine which has a compressor which is configured to compress air, a combustor which combusts a fuel in the air compressed by the compressor to generate a combustion gas, and a turbine which is driven by the combustion gas,
wherein the boiler is an exhaust heat recovery boiler which has an exhaust gas which is a combustion gas exhausted from the turbine, as the heating fluid.

12. The boiler plant according to claim 11, further comprising:
an air cooler which is configured to perform heat exchange between a portion of high-temperature and high-pressure air compressed by the compressor and a first cooling medium, is configured to heat the first cooling medium while cooling the air from the compressor, and feeds the cooled air to a high temperature component of the gas turbine being in contact with the combustion gas,
wherein the heater has the air cooler which has steam, which is a heating target of the heater, as the first cooling medium.

13. The boiler plant according to claim 11,
wherein a medium passage through which a second cooling medium passes is formed in a high temperature component of the gas turbine being in contact with the combustion gas, and
wherein the heater has the high temperature component which has steam, which is a heating target of the heater, as the second cooling medium.

14. The boiler plant according to claim 11,
wherein the compressor has a first compression unit which is configured to compress air and a second compression unit which is further configured to compress the air compressed by the first compression unit,
wherein the boiler plant further comprises:
an intermediate cooler which is configured to perform heat exchange between the air compressed by the first compression unit and a third cooling medium, heat the third cooling medium while cooling the air from the first compression unit, and feed the cooled air to the second compression unit,
wherein the heater has the intermediate cooler which has steam, which is a heating target of the heater, as the third cooling medium.

15. The boiler plant according to claim 11, further comprising:
a fuel preheater which is configured to heat the fuel flowing into the combustor by a steam heating medium heated by the heater.

16. A method for operating a boiler plant,
the boiler plant including a boiler which has one or more evaporators which is configured to heat water by a heating fluid to generate steam, a steam utilization device which is configured to use the steam from the boiler, and a connection line which connects the boiler and the steam utilization device to each other,
the method comprising:
a steam generation step of heating, by a first evaporator having a highest internal pressure from among the one or more evaporators, water having a temperature lower than a constant pressure specific heat maximum temperature, at which constant pressure specific heat in a pressure in the first evaporator is maximum, to be equal to or higher than the constant pressure specific heat maximum temperature; and
a heating step of heating, by using at least energy excluding thermal energy of the heating fluid, steam having a temperature lower than the constant pressure specific heat maximum temperature from among steam in the steam utilization device, the connection line, and an intra-boiler line to be equal to or higher than the constant pressure specific heat maximum temperature.

17. The method for operating a boiler plant according to claim 16,
wherein the heating step includes a boiler outside heating step of heating steam using only the energy excluding the thermal energy of the heating fluid.

18. The method for operating a boiler plant according to claim 16,
wherein the steam utilization device has a steam turbine, and
wherein in the heating step, exhaust steam exhausted from the steam turbine is heated.

19. The method for operating a boiler plant according to claim 16,
wherein the steam utilization device has a first steam turbine which is driven by steam and a second steam turbine which is driven by steam having a pressure lower than that of the first steam turbine, and
wherein in the heating step, exhaust steam exhausted from the first steam turbine is heated, and
wherein the exhaust steam heated in the heating step is fed to the second steam turbine.
